(19) United States
(12) Patent Application Publication
(10) Pub. No.: US 2026/0289408 A1
(43) Pub. Date: Sep. 24, 2026

(54) SYSTEM

(71) Applicant: SoftBank Group Corp., Tokyo (JP)

(72) Inventor: Kazuhiro SATO, Tokyo (JP)

(73) Assignee: SoftBank Group Corp., Tokyo (JP)

(21) Appl. No.: 19/567,015

(22) Filed: Mar. 14, 2026

(30) Foreign Application Priority Data
Mar. 19, 2025 (JP) 2025-045283

(51) Int. Cl. G06N 20/00

(52) U.S. Cl. CPC G06N 20/00

(57) ABSTRACT

A system includes a processor that is configured to collect information input data, browsing data, and post data of an information sharing service in order to learn daily information activities of a user, analyze the collected data and use a generative AI model to extract behavior patterns and preferences of the user, and generate a prompt for instructing creation of an informational personality of the user based on the extracted information, and input the prompt to the generative AI model.

### CROSS-REFERENCE TO RELATED APPLICATION

This application is based on and claims priority under 35 USC 119 from Japanese Patent Application No. 2025-045283 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for personalizing digital services typically rely on simple statistical profiling or rule-based preference settings, such as explicit user choices, basic recommendation logs, or keyword-based filters. These systems are limited in their ability to capture complex, latent aspects of a user's behavior patterns, preferences, and informational personality that are implicitly expressed through daily information activities, including text input, web browsing, and posting on information sharing services. As a result, such systems fail to generate highly context-sensitive, user-specific responses that reflect the user's nuanced interests, tone, and behavioral characteristics. Furthermore, existing techniques generally do not provide a systematic framework in which a generative AI model is guided, by way of prompts derived from user behavior analysis, to construct and utilize an informational personality of the user. Therefore, there is a need for a system that can automatically learn a user's daily information activities, extract behavior patterns and preferences using a generative AI model, construct an informational personality of the user based on the extracted information, and generate responses that are accurately adapted to the user's preferences.

### SUMMARY

In order to solve the above-described problems, a system according to at least one embodiment includes a processor configured to collect information input data, browsing data, and post data of an information sharing service in order to learn daily information activities of a user; analyze the collected data and use a generative AI model to extract behavior patterns and preferences of the user; and generate a prompt for instructing creation of an informational personality of the user based on the extracted information, and input the prompt to the generative AI model. The processor may further be configured to generate a response corresponding to the preferences of the user by using the generative AI model, and to provide the generated response to the user. By collecting heterogeneous data that reflects the user's actual information activities, deriving prompts that encode the extracted behavior patterns and preferences, and supplying these prompts to the generative AI model, the system constructs and exploits a user-specific informational personality. Consequently, the system can generate and deliver responses that are more closely aligned with the user's individual characteristics and informational needs.

The term “information input data” refers to digital text or other information that a user actively inputs through an input interface of a terminal or application, including but not limited to messages, emails, search queries, form entries, and document texts.

The term “browsing data” refers to information related to web or application browsing activities of a user, including but not limited to accessed URLs, page titles, timestamps, and metadata associated with the viewed content.

The term “post data of an information sharing service” refers to information that a user posts, publishes, or shares via an online platform or service that enables information sharing among multiple users, including but not limited to social networking services, microblogging services, forums, and online communities.

The term “daily information activities” refers to routine digital activities performed by a user in an information environment, including but not limited to text input, web or application browsing, and posting or interacting on information sharing services over time.

The term “generative AI model” refers to an artificial intelligence model that generates output data, such as text or other content, based on input data, including but not limited to large language models, neural network-based generative models, and similar machine learning models capable of producing new content in response to prompts.

The term “behavior patterns of the user” refers to recurring or characteristic tendencies in the user's digital activities, including but not limited to typical usage times, interaction styles, frequently performed actions, and habitual sequences of operations or expressions.

The term “preferences of the user” refers to explicit or implicit likes, dislikes, interests, priorities, or tendencies of the user, inferred from the user's information input data, browsing data, and post data of an information sharing service.

The term “informational personality of the user” refers to a structured representation of the user's information-related characteristics, including but not limited to behavior patterns, preferences, writing style, and typical expressions, which is used by the system to generate responses that are adapted to the user.

The term “prompt” refers to data supplied as input to the generative AI model, including but not limited to instructions, contextual information, or parameterized text, that guides the generative AI model to perform a specific operation, such as constructing the informational personality of the user or generating a response.

The term “response” refers to output information generated by the generative AI model on the basis of the prompt and the informational personality of the user, including but not limited to text messages, replies, or other content that is adapted to the user's preferences.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

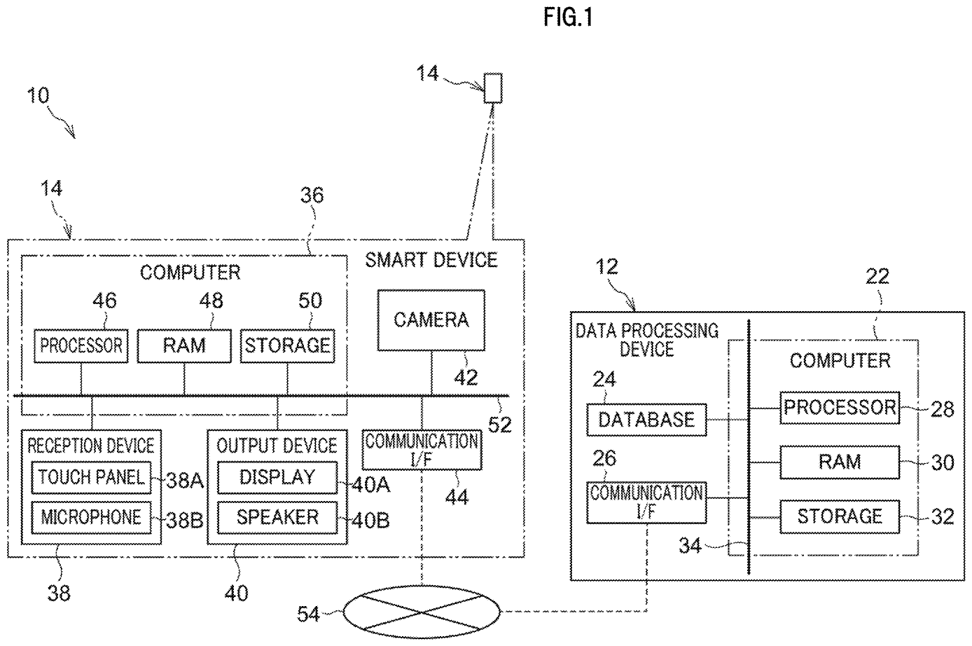

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

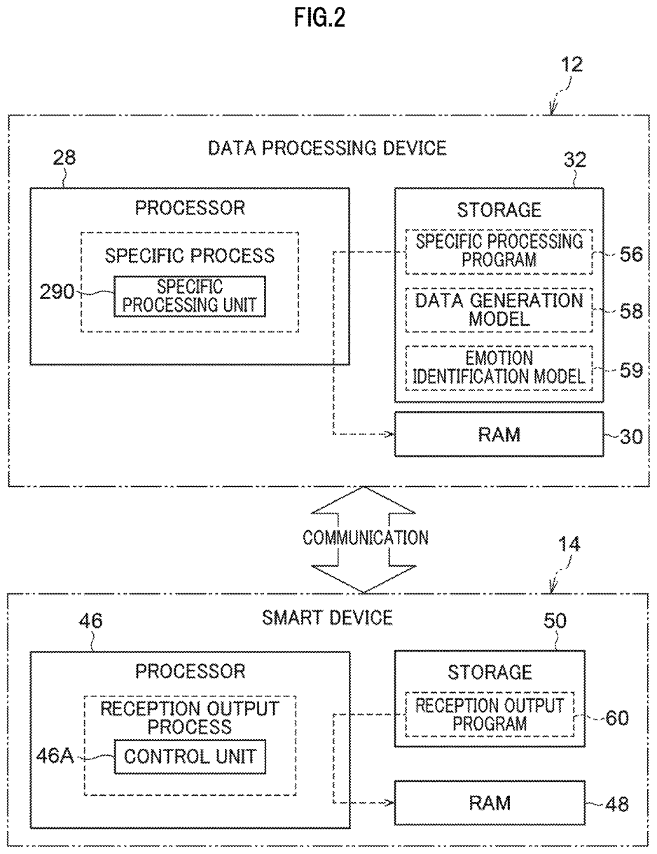

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented personalization techniques typically rely on shallow user profiles that are derived from limited and siloed data sources, such as explicit preferences or short-term interaction logs. These techniques often treat user data as static attributes and do not continuously re-model the user's evolving behavior across heterogeneous digital activities. As a result, such systems tend to generate recommendations and responses that are generic, context-insensitive, and poorly aligned with the user's long-term behavioral patterns and preferences.

Moreover, conventional systems usually separate profile construction logic from the operation of machine-learned models. Prompt sentences or query structures provided to machine-learned models are often handcrafted, fixed, and not systematically adapted to each individual user's behavioral characteristics. This separation leads to suboptimal utilization of computing resources, because the generative model cannot fully leverage rich, structured representations of user behavior that span input operations, browsing actions, and posting activities. In addition, when user behavior changes over time, conventional systems do not efficiently update both the user representation and the generative model in a coordinated, automated manner, thereby degrading prediction accuracy and responsiveness.

From a computer technology standpoint, there is a need for an improved data processing architecture that (i) unifies collection, storage, and transformation of multi-source user activity data into machine-usable feature information, (ii) integrates such feature information directly into the training and inference operations of a generative AI model, and (iii) automatically generates and adapts model input prompt sentences based on a user-specific personality profile. Without such an integrated mechanism, computing devices cannot maintain a robust, consistent “informational personality” representation that is usable for high-quality, user-specific generation of response information or recommendation information, including in situations where the user is not actively present. Accordingly, a technical problem exists in how to improve the functioning of a computer system so that a processor can: (1) efficiently capture and normalize heterogeneous user activity data from a terminal; (2) transform the normalized data into structured feature information that characterizes user behavior and preferences; (3) use the resulting feature information to construct and update a generative AI model and a user-specific personality profile in a continuous feedback loop; and (4) automatically construct prompt sentences and perform inference to generate personalized outputs with reduced manual configuration and improved computational consistency. Addressing this problem requires specific data structures, processing steps, and control logic that go beyond the mere execution of generic machine learning algorithms and instead define a concrete improvement in the way the computer system processes and uses user activity data for generative modeling.

The specific processing by the specific processing unit 290 of the data processing device 12 in Example 1 is realized by the following means.

The present invention provides a server comprising a processor configured to receive and store, from a terminal, information input data, browsing data, and posting data in an information sharing service as daily information activities of a user; to preprocess and structure the stored information input data, browsing data, and posting data using a database management function and a natural language processing function to generate feature information indicating behavioral characteristics and preference characteristics of the user; to construct a training data set for a generative AI model operating on a machine learning platform by using the feature information and the stored data, and to train the generative AI model to generate a model state representing an informational personality specific to the user and a personality profile for each user; to automatically generate a prompt sentence to be input to the generative AI model on the basis of the personality profile for each user and the stored data, to input the prompt sentence and the personality profile to the generative AI model, and to generate response information or recommendation information corresponding to the informational personality of the user; and to transmit the generated response information or recommendation information to the terminal so that the response information or recommendation information is presented to the user via the terminal. This enables the computer system to implement an integrated, machine-oriented processing pipeline that continuously converts heterogeneous user activity logs into structured feature information, maintains and updates a user-specific informational personality within a generative AI model, and automatically forms model-specific prompt sentences, thereby improving the technical functioning of the server in generating contextually consistent, personalized responses and recommendations with reduced manual intervention and enhanced adaptability to changes in user behavior.

The term “system” refers to a collection of one or more information processing apparatuses, including at least a server and one or more terminals, that cooperate to perform the functions described in the claims.

The term “server” refers to an information processing apparatus including at least one processor, memory, and communication interface, configured to execute programs for receiving, storing, processing, and generating data as described in the claims.

The term “terminal” refers to a user-operated information processing apparatus, such as a computing device having an input interface, a display interface, and a communication interface, configured to transmit user activity data to the server and to present information received from the server.

The term “processor” refers to one or more hardware processing units, such as a central processing unit or a graphics processing unit, capable of executing instructions to perform the data processing operations described in the claims.

The term “information input data” refers to digital data representing user-provided input, including text, commands, or other content entered by the user through an input interface of the terminal.

The term “browsing data” refers to digital data representing access by the user to network resources, including identifiers of accessed network locations, access times, and associated context information.

The term “posting data” refers to digital data representing content provided by the user to an information sharing service, including messages, comments, media-related information, and associated metadata.

The term “information sharing service” refers to a network-based service or platform that enables users to publish, share, or exchange digital content with other users or systems.

The term “daily information activities” refers to recurring or habitual digital actions performed by the user via the terminal, including information input operations, browsing operations, and posting operations.

The term “database management function” refers to a software-controlled capability executed by the processor to store, organize, query, and update structured data in a data storage system.

The term “natural language processing function” refers to a software-controlled capability executed by the processor to analyze, transform, or interpret text data expressed in a human language, including tasks such as tokenization, syntactic analysis, semantic analysis, or sentiment analysis.

The term “feature information” refers to structured data derived from raw user activity data, including numerical or categorical values that characterize behavioral characteristics or preference characteristics of the user.

The term “behavioral characteristics” refers to patterns or tendencies in the user's digital actions, including frequency, timing, and types of interactions observed in the user's daily information activities.

The term “preference characteristics” refers to patterns or tendencies in the user's interests or likes, inferred from content, topics, or categories present in the user's daily information activities.

The term “generative AI model” refers to a machine-learned model, such as a probabilistic or neural network-based model, configured to generate data outputs, including text or other content, based on learned parameters and input context.

The term “machine learning platform” refers to a software and hardware environment that supports training and inference of machine-learned models, including libraries, frameworks, and computational resources used to execute learning algorithms.

The term “training data set” refers to a collection of data samples, including user activity data and associated feature information, used to adjust parameters of the generative AI model during a training process.

The term “model state” refers to a set of learned parameters and internal representations of the generative AI model obtained after training, which determine the behavior of the model during inference.

The term “informational personality” refers to a representation, embodied in the model state and associated data, that characterizes the user's typical expression style, behavioral patterns, and preference tendencies in digital information exchange.

The term “personality profile” refers to user-specific structured data derived from the model state and feature information, used to parameterize or condition the generative AI model so as to reflect the informational personality of the corresponding user.

The term “prompt sentence” refers to a text or structured input sequence provided to the generative AI model that specifies a request, instruction, or context for generating response information or recommendation information.

The term “response information” refers to content generated by the generative AI model in response to a prompt sentence, including text, summaries, explanations, or simulated user-like messages.

The term “recommendation information” refers to content generated or selected by the server, based at least in part on the generative AI model and the personality profile, indicating suggested items, resources, or content likely to be of interest to the user.

The term “stored data” refers to information input data, browsing data, posting data, and any derived or associated data that are saved in a storage system controlled by the server.

The term “communication interface” refers to hardware and software components that enable data exchange between the server and the terminal or between the server and other information processing apparatuses.

The term “third party” refers to an entity other than the user and the operator of the server, including another user or another information processing apparatus that receives dialogue text or message content generated by the generative AI model.

The term “dialogue text” refers to generated text representing a conversational utterance or sequence of utterances that are suitable for use in a dialogue context.

The term “message content” refers to generated text or structured information that is suitable for transmission as a message in a communication or information sharing environment.

In one embodiment, a system includes a server and one or more terminals connected via a communication network. The server includes at least one processor, a memory, a non-volatile storage device, and a network interface. The terminal includes at least one processor, a memory, a user input interface, a display interface, and a network interface. The server and the terminal execute stored programs to realize the functions described below.

The terminal operates as an interface between a user and the server. The terminal executes an operating system and one or more client applications, such as a web browser application, a messaging application, and an information sharing application. The terminal acquires user operations via a keyboard, a touch panel, a pointing device, a microphone, or other input devices, and displays information from the server on a display device such as a liquid crystal display or an organic light-emitting display.

The server operates as a central data processing node. The server executes an operating system, a web server process, an application server process, a database management process, and a machine learning process. The server uses a database management system, such as a relational database management system, to store user activity data and associated feature information. The server uses a data analysis environment, such as a scripting language runtime with numerical libraries, and a machine learning framework, such as a neural network framework, to implement a generative AI model and to maintain an informational personality representation for each user.

The server configures a storage schema in the database management system to store heterogeneous user activity data in a machine-usable form. The server defines multiple tables, such as a user input table, a browsing table, and a posting table. The user input table stores fields such as a user identifier, a timestamp, an input type, and a text content field. The browsing table stores fields such as a user identifier, a timestamp, a resource locator, a referrer locator, and a device type. The posting table stores fields such as a user identifier, a timestamp, a service identifier, a post text field, a media flag, and engagement indicators. The server normalizes incoming data into these tables and maintains indices for efficient retrieval by user and by time.

The terminal collects daily information activities of the user during normal usage. The terminal records input text entered into text fields of applications, such as messages, search queries, and comments, as information input data. The terminal records resource locators of visited network resources, together with timestamps and referrer information, as browsing data. The terminal records text contents of posts, reactions, and comments submitted to information sharing services, as well as associated metadata such as tags and reaction counts, as posting data. The terminal assigns a user identifier or device identifier to each record and temporarily stores these records in a local data structure, such as a buffer or a local log file.

The terminal periodically transmits batches of the stored activity data to the server. The terminal groups multiple records into a batch according to a time window or a record count threshold. The terminal encodes the batch into a structured message, such as a sequence of key-value pairs representing field names and values. The terminal compresses the structured message using a lossless compression algorithm to reduce the data size. The terminal establishes a secure communication connection to the server via a network protocol and transmits the compressed message as a request payload. The terminal then deletes locally stored records or marks them as transmitted after confirmation from the server.

The server receives user activity data via the network interface. The server terminates the secure communication protocol, decompresses the received message, and parses the structured data. The server validates a user identifier and checks data format consistency. The server converts timestamps into a common time standard and normalizes text encodings, for example to a standard character set. The server then inserts the parsed records into the appropriate database tables. The server associates each record with a persistent user identifier that is unique across terminals.

The server, after accumulating user activity data, generates feature information that describes behavioral characteristics and preference characteristics of the user. The server reads batches of data from the database. The server uses a natural language processing function implemented by a text processing library to process text fields of input data and posting data. The server tokenizes text into discrete tokens, normalizes case and punctuation, and removes function words. The server applies a part-of-speech analysis and a named entity recognition analysis to extract entities such as organization names, location names, and product types. The server applies a sentiment classification model to each text record and assigns a sentiment score. The server aggregates occurrences of tokens and entities across time to derive per-user topic frequencies and sentiment distributions.

The server also derives temporal and statistical features from browsing data and posting data. The server computes histograms of activities over time-of-day and day-of-week to characterize typical usage patterns. The server computes frequency counts of visited domains, categories of resources, and types of content accessed. The server encodes these statistics into numeric feature vectors, such as real-valued vectors representing normalized frequencies, and categorical features, such as one-hot encodings of dominant categories.

The server maintains a feature store that links a user identifier to corresponding feature information. The feature store includes, for each user, a vector representing global preferences over topics, a vector representing recent activity topics, an array representing temporal activity patterns, and additional fields representing sentiment distributions and engagement measures. The server updates this feature information incrementally when new activity data arrives, rather than recomputing all features from scratch. This incremental update uses differential counting and exponential moving averages, which reduces processing time and ensures that recent behavior has a stronger influence.

The server implements a generative AI model as a parametric neural network configured to generate text sequences and to support conditioned generation based on user-specific features. In one embodiment, the server employs a transformer-based neural network with multiple self-attention layers, feed-forward layers, and normalization layers. The server defines a vocabulary and a tokenizer that convert characters or subword units into discrete token identifiers. The server embeds tokens into continuous vectors using a learned embedding matrix. The server further projects user feature information, such as topic preference vectors and temporal patterns, into a conditioning vector that is combined with the token embeddings or attention mechanism. This conditioning mechanism allows the generative AI model to modulate output according to the informational personality of the user.

The server trains the generative AI model using the accumulated user activity data. The server constructs a training data set in which each sample includes a sequence of tokens representing user-generated text, such as posts or input text, together with associated context labels, such as topic vectors and temporal features. The server segments long texts into sequences of fixed maximum length. The server uses a loss function, such as cross-entropy loss between predicted token probabilities and actual next tokens, to quantify prediction error. The server applies a gradient-based optimization method, such as a variant of stochastic gradient descent, to update model weights. The server optionally uses regularization techniques, dropout, and learning rate scheduling to improve generalization performance and stability.

The server may adopt data augmentation methods to enhance model robustness. The server can partially mask or reorder tokens within a sequence to encourage the model to reconstruct original text. The server can sample different segments from longer documents to increase diversity of training inputs. These operations alter the training data in ways not tied to human manual editing and improve the generalization ability of the model to generate coherent text under varying contexts.

The server, upon completion or during training, derives an informational personality representation for each user. The server stores, together with model parameters, a user-specific personality profile constructed from the feature store. The personality profile includes user-specific parameter values or embeddings that the generative AI model uses during inference. The server may, for example, maintain a user embedding matrix where each row corresponds to a user identifier and is learned jointly with other model parameters. This user embedding functions as a compact representation of long-term user behavior and preferences.

The server uses the personality profile not only as static context but also as a basis for constructing prompt sentences. The server generates a prompt sentence by algorithmically combining user-specific topics, recent activity keywords, and requested task types. The server uses rule-based templates or learned templates to construct a text instruction that guides the generative AI model. For example, the server may include explanatory clauses indicating time periods, domains of interest, and output formats. This process ensures that prompt sentences are consistently adapted to each user, rather than relying on generic, manually authored prompts.

The server, in one embodiment, generates and uses prompt sentences such as:
“From the user's recent social media posts, extract the top three topics of interest and generate a short summary for each topic in the user's typical writing style.”
“Analyze the user's browsing history for the past week and recommend five news articles that match the user's informational personality regarding technology and environment.”
“Using the generative AI model, compose a reply that the user would plausibly post in response to a question about electric vehicles and renewable energy.”
“Generate a weekly activity report that explains how the user's interests have shifted compared to the previous week, and present the report in a friendly and concise tone.”
“Predict three new topics that the user is likely to become interested in next month and generate a brief explanation for each prediction based on the user's past digital activity.”

The server, when it receives a prompt sentence from the terminal or generates a prompt sentence internally, tokenizes the prompt text using the same tokenizer used during training of the generative AI model. The server then combines the tokenized prompt with the user-specific embedding and topic feature vectors. The server feeds this combined representation into the transformer layers to generate output tokens. The server adopts a decoding strategy, such as beam search or probabilistic sampling with temperature control, to generate a sequence of tokens. The server then converts the output token sequence into natural language text and may perform post-processing such as filtering of undesired terms, truncation to a maximum length, and enforcement of grammatical constraints.

The server then composes response information or recommendation information based on the generated text and, where applicable, external data sources. For example, when the generative AI model outputs a list of topics, the server can query a content catalog or an external service to retrieve candidate items. The server ranks the candidates using similarity metrics between item attributes and user preference features in the personality profile. This ranking may rely on vector similarity in an embedding space or on heuristic scores combining recency and relevance. The server embeds resulting item identifiers and descriptions into a response payload and transmits the payload to the terminal.

The terminal receives the response payload from the server and parses it. The terminal extracts generated text, titles, links, and other display information from the payload. The terminal renders the information on its display in a structured layout, such as a chat-like interface, a list of recommendations, or a notification panel. The terminal allows the user to interact with the generated content by selecting links, responding to generated messages, or providing explicit ratings. These interactions become new activity data that the terminal sends back to the server, thereby closing a feedback loop.

The system provides technical improvements over conventional systems in several ways. The server uses a unified data schema and feature store to avoid redundant parsing and manual feature extraction, which reduces processing time and memory usage. The incremental feature update mechanism allows the server to update user profiles without recomputing from all historical data, which improves scalability and reduces computational load. The conditioning of a transformer-based generative AI model with user-specific embeddings and structured feature vectors allows the model to capture long-term user behavior patterns with higher accuracy than simple short-term histories. As a consequence, the system improves prediction accuracy and relevance of generated content.

The server also reduces communication overhead by performing compression and batch transmission control. The terminal aggregates multiple user activity records before sending them, which reduces the number of network packets and protocol handshakes, thereby decreasing network load and latency. The server maintains indexed tables and uses efficient query plans in the database management system to minimize latency when retrieving data for model training and inference.

The system improves computer technology itself by introducing a specific data flow and parameterization strategy that is not equivalent to manual human processing. The server operates an internal user embedding space and a topic feature space that cannot be directly reproduced by human operators. The server uses non-linear transformations and attention mechanisms in the generative AI model to integrate multiple heterogeneous signals (text content, browsing patterns, interaction times) into a single representation. This integration is performed through vector operations, matrix multiplications, and non-linear activations, which provide a high-dimensional representation space for decision-making. This structure allows the system to detect subtle correlations and temporal trends that are impractical for manual processing, and to adjust response generation behavior in real time.

The system can be implemented in different embodiments. In one alternative embodiment, the server employs a recurrent neural network architecture or a hybrid architecture instead of a pure transformer, while still using user feature vectors as conditioning inputs. In another embodiment, the server stores user personality profiles in a non-relational datastore with a document structure, while maintaining synchronization with a relational database used for raw activity logs. In yet another embodiment, the server distributes model training across multiple compute nodes and aggregates parameter updates using a parameter server or federated learning arrangement, while still generating prompt sentences on a per-user basis.

The server, in another embodiment, may implement rule-based fallback behaviors for users with limited data. In such cases, the server initializes a personality profile with default values representing an average user and then gradually personalizes the profile as data accumulates. The generative AI model can be configured to condition more strongly on general topic trends in the absence of sufficient user-specific history. This configuration ensures stable operation in early stages while still converging to a highly personalized state over time.

The server can also be configured to generate dialogue text or message content based on a user's informational personality when the user is absent or deceased. In such a scenario, the server does not receive new activity data from the user but still maintains the personality profile and uses it to generate content to be presented to third parties. This usage requires stable and consistent personality modeling, which is achieved by the combination of long-term feature accumulation, user embeddings, and structured prompt generation. The server ensures that the generative AI model reproduces characteristic phrasing and topic preferences of the user as captured before absence, which is a specific technical use of stored model state and user-specific parameters.

By fixing the structure of data flow, the specific data schemas, the feature generation logic, the neural network architecture, and the prompt sentence construction mechanism, the system achieves measurable improvements in processing efficiency, storage efficiency, and personalization accuracy when compared to systems that use ad hoc or manual configurations. The integration of these components into a single server-controlled pipeline ensures that the processing is more than a mere automation of human tasks and instead constitutes an improvement in how computing devices represent and transform heterogeneous user activity data for generative modeling.

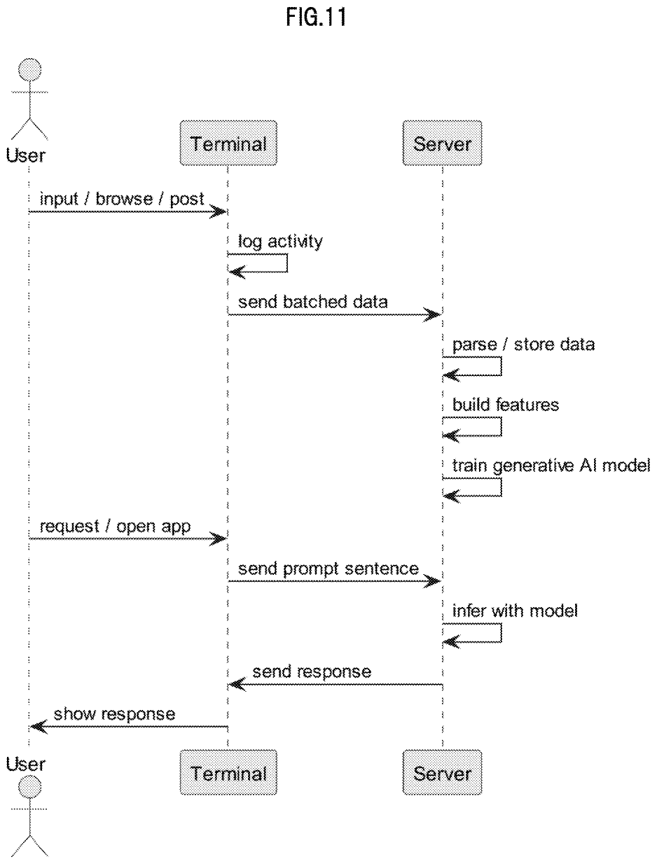

The following describes the processing flow using FIG. 11.

### Step 1:

Terminal captures user activity

Terminal monitors user operations on applications such as a browser, a messaging application, and an information sharing application. Terminal records, as information input data, text that User enters via a keyboard or touchscreen, such as search queries, messages, or comments. Terminal records, as browsing data, resource locators that User visits, together with timestamps and referrer information. Terminal records, as posting data, text of posts, comments, and reactions that User submits to information sharing services, along with metadata such as tags and engagement counts. The input of this step is raw user interactions with the terminal user interface. The output of this step is a set of structured activity records containing fields such as user identifier, timestamp, application type, content text, and resource locator.

### Step 2:

Terminal batches and prepares activity data for transmission

Terminal periodically examines the stored activity records and groups them into batches based on a time window or record count threshold. Terminal converts each batch into a structured message, for example a sequence of key-value pairs representing each record and its fields. Terminal compresses the structured message using a lossless compression algorithm and encrypts the compressed data through a secure communication protocol.

Terminal attaches an authentication token that identifies User. The input of this step is the previously stored activity records produced in Step 1. The output of this step is an encrypted, compressed batch payload ready for network transmission.

### Step 3:

Terminal sends batched data to server

Terminal establishes a secure network connection to Server using a communication protocol stack. Terminal transmits the encrypted, compressed batch as a request payload to a designated endpoint on Server. Terminal waits for an acknowledgment from Server that indicates successful or failed reception and storage. If Server returns a success acknowledgment, Terminal marks the corresponding local records as transmitted or deletes them. The input of this step is the encrypted, compressed batch payload from Step 2. The output of this step is a delivered network message at Server and a cleaned or updated local log state at Terminal.

### Step 4:

Server receives and parses transmitted data

Server accepts the incoming network request through a network interface and terminates the secure protocol, thereby decrypting the payload. Server decompresses the payload to recover the structured message and parses the message into individual user activity records. Server validates fields such as user identifier, timestamp format, and required fields. Server converts timestamps into a canonical time zone and normalizes text encodings. The input of this step is the encrypted, compressed batch arriving from Terminal. The output of this step is a set of validated and normalized activity records in an internal data structure at Server.

### Step 5:

Server stores normalized activity records in database

Server inserts the validated activity records into appropriate tables in a database management system. Server maps each record to a user input table, a browsing table, or a posting table, based on a record type field. Server fills columns such as user identifier, timestamp, content text, resource locator, service identifier, and engagement indicators, and executes database insert operations within a transaction. Server updates indices on user identifier and timestamp columns to support efficient querying. The input of this step is the set of normalized activity records from Step 4. The output of this step is a set of persistent database rows representing user activity, indexed and queryable by Server.

### Step 6:

Server aggregates and retrieves activity data for feature generation

Server periodically launches a data aggregation process that queries the database for new or updated records since a previous processing time. Server retrieves relevant rows from the input table, browsing table, and posting table for each user, and groups them by user identifier. Server may limit the retrieval window to a configurable recent time period for efficient processing. The input of this step is the persistent database content stored in Step 5 and a time range or checkpoint marker. The output of this step is a collection of per-user datasets containing text fields and associated metadata, ready for feature extraction.

### Step 7:

Server performs natural language preprocessing on text fields

Server processes the text fields contained in the per-user datasets, including input texts and post texts. Server uses a natural language processing function to tokenize each text string into tokens, normalize case and punctuation, and remove stop-words. Server applies part-of-speech tagging and named entity recognition to identify entities such as organizations, locations, and product categories. Server applies a sentiment classifier to assign a polarity score or category to each text entry. The input of this step is the per-user datasets from Step 6 containing raw text fields. The output of this step is augmented datasets in which each text record is associated with token lists, entity lists, and sentiment scores.

### Step 8:

Server computes behavioral and preference feature information

Server aggregates token frequencies, entity occurrences, and sentiment distributions over the text records for each user. Server calculates statistics for browsing data, such as counts of visits per resource domain, visit frequencies per hour, and per-day patterns. Server combines these statistics into numerical vectors and categorical representations that characterize user behavior and preferences. Server may compute, for example, a topic frequency vector, a temporal activity histogram, and sentiment distribution values. The input of this step is the augmented datasets from Step 7 and the browsing metadata from Step 6. The output of this step is feature information for each user, represented as structured feature vectors and associated descriptors.

### Step 9:

Server updates a feature store with user feature information

Server writes the generated feature information into a feature store that links each user identifier to corresponding feature vectors and summary fields. Server updates existing feature entries by incrementally adjusting counts and applying exponential moving averages, instead of overwriting entire histories. Server records timestamps of feature updates to track recency. The input of this step is the newly computed feature information from Step 8 and the existing feature store content. The output of this step is an updated feature store containing, for each user, current behavioral characteristics and preference characteristics.

### Step 10:

Server prepares training data samples for the generative AI model

Server constructs training samples by pairing user-generated text sequences with corresponding feature information from the feature store. Server retrieves sequences of tokens from text records and aligns them with user-specific topic vectors, temporal patterns, and sentiment indicators. Server segments long texts into sequences of a fixed maximum length and encodes tokens into integer identifiers using a tokenizer. Server groups encoded sequences and feature vectors into mini-batches suitable for neural network training. The input of this step is the per-user text data from the database and the feature store from Step 9. The output of this step is a training dataset containing tokenized sequences and aligned feature vectors.

### Step 11:

Server configures and initializes the generative AI model

Server creates an instance of a generative AI model implemented as a multi-layer neural network, such as a transformer-based architecture. Server defines hyperparameters including the number of layers, the dimensionality of token embeddings, the number of attention heads, and the maximum sequence length. Server initializes model parameters, such as weight matrices and bias vectors, either randomly or from a pre-trained checkpoint. Server allocates computational resources, such as processor cores or accelerators, and loads model parameters into memory. The input of this step is a model configuration specification and, optionally, an initial parameter set. The output of this step is an initialized generative AI model instance ready to accept training data.

### Step 12:

Server trains the generative AI model with user-conditioned data

Server feeds the mini-batches of token sequences and corresponding user feature vectors into the generative AI model. Server computes, for each batch, predicted probability distributions over next tokens, and calculates a loss value using a loss function such as cross-entropy between predicted and true tokens. Server performs backpropagation to compute gradients of the loss with respect to model parameters and updates the parameters using an optimization algorithm. Server repeats this process over multiple epochs, periodically evaluating validation performance and adjusting learning rates or other hyperparameters. The input of this step is the training dataset from Step 10 and the initialized model from Step 11. The output of this step is a trained generative AI model with parameters that encode user-conditioned language generation behavior.

### Step 13:

Server derives and stores a personality profile for each user

Server extracts user-specific representations from the trained model by, for example, maintaining a user embedding matrix whose rows correspond to users. Server associates each user identifier with a learned embedding vector that summarizes long-term behavior and preferences. Server complements this embedding with the feature vectors in the feature store to form a personality profile. Server stores, in a dedicated data structure, references to the model version, the user embedding vector, and the latest feature vectors. The input of this step is the trained generative AI model from Step 12 and the feature store from Step 9. The output of this step is a set of personality profiles that represent informational personalities for respective users.

### Step 14:

Server generates a prompt sentence tailored to a user

Server constructs a prompt sentence by combining template text with user-specific information from the personality profile. Server selects relevant topics, time ranges, and content types from the feature vectors, and fills a prompt template accordingly. For example, Server may insert the most frequent topics and specify a requested output format. Server then creates a final prompt sentence in natural language that instructs the generative AI model to perform a particular generation task conditioned on the user's informational personality. The input of this step is a personality profile from Step 13 and, optionally, a requested task type from Terminal or User. The output of this step is a user-specific prompt sentence designed for input to the generative AI model.

### Step 15:

Server executes inference using the generative AI model and the prompt sentence

Server tokenizes the generated prompt sentence and encodes it into token identifiers. Server retrieves the corresponding user embedding and feature vectors from the personality profile.

Server feeds the tokenized prompt, user embedding, and feature vectors into the generative AI model as context. Server generates output tokens using a decoding strategy, such as greedy decoding or sampling, until a termination condition is met. Server converts the sequence of output tokens into a text string representing response information or recommendation instructions. The input of this step is the prompt sentence from Step 14 and the personality profile from Step 13. The output of this step is generated text tailored to the user's informational personality.

### Step 16:

Server composes response information or recommendation information

Server interprets the generated text as either direct response content or as a set of instructions or topics for recommendation. If recommendations are requested, Server queries content sources or internal catalogs using the topics extracted from the generated text. Server ranks candidate items by computing similarity measures between item attributes and user preference features in the personality profile. Server packages the generated text, ranked items, and associated metadata into a response object suitable for transmission. The input of this step is the generated text from Step 15 and, optionally, external content data. The output of this step is a structured response object containing response information or recommendation information.

### Step 17:

Server transmits the response object to the terminal

Server serializes the response object into a structured format and sends it to Terminal via the network interface using a communication protocol. Server may compress and encrypt the response to ensure efficient and secure transport. Server records logs of the transmitted response for auditing and monitoring. The input of this step is the response object from Step 16. The output of this step is a delivered response message available to Terminal and an updated server-side log entry.

### Step 18:

Terminal presents the generated information to the user

Terminal receives the response message from Server and deserializes it to recover the response object. Terminal extracts generated text, recommended item titles, links, and other presentation fields. Terminal displays this content through its user interface, for example in a chat view, a list of recommended articles, or a notification area. Terminal provides interactive elements, such as buttons or links, allowing User to open recommended resources or reply to generated messages. The input of this step is the response message from Step 17. The output of this step is a rendered user interface presenting the response information or recommendation information to User.

### Step 19:

User interacts with the presented information and generates new activity

User reads the generated response information and recommendation information displayed on Terminal. User may click links, open recommended content, or provide feedback such as likes, dislikes, or text replies. These interactions generate new input text, browsing actions, and posting actions. Terminal records these new interactions as new activity data and feeds them back into the process described in Step 1 onward. The input of this step is the displayed information on Terminal and user decisions. The output of this step is additional user activity data that further refines the informational personality and subsequent generations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision systems suffer from technical limitations in how they model user behavior and generate personalized content. Typical systems rely on relatively simple, rule-based filtering or static profile data, such as manually selected interests or coarse-grained categories. As a result, a processor in such systems processes user interaction data in a limited manner, for example by counting page views or keyword occurrences, without constructing a rich representation of a user's information activity pattern over time. This leads to several technical problems.

First, conventional systems are not configured to continuously integrate heterogeneous digital activity data, such as character-based input, viewing of information resources, and postings on information sharing platforms, into a unified, machine-usable representation. The processor commonly stores such data in separate, loosely coupled logs and applies only minimal normalization and feature extraction. Consequently, the system cannot efficiently derive high-resolution behavioral feature values that characterize a user's information interest level, information usage tendency, and information activity pattern. This degrades the quality of downstream processing, such as ranking and selection of information resources.

Second, even when a generative AI model is employed, conventional systems often provide only generic or manually crafted prompts that are not tightly coupled to a learned user representation. The processor typically sends to the generative AI model a prompt sentence that is independent of detailed analysis of the user's past activity, or that references only a small subset of such activity. This causes the generative AI model to operate on suboptimal context, producing responses that are not well aligned with the user's actual preferences, reading style, or desired information format. From a computer-technical perspective, the computational resources of the generative AI model and the server are used inefficiently, because many generated outputs are not relevant and must be discarded or ignored.

Third, conventional systems lack a robust feedback loop in which the processor uses fine-grained usage history—such as viewing, selection, and rejection operations on generated information—to iteratively refine an internal user representation and adapt subsequent prompts and generation behavior. Usage data is often logged for analytical reporting but is not fed back into the personalization pipeline at the level of the prompt construction and similarity computation. As a result, the system cannot progressively improve its internal models, and the quality of personalization stagnates or degrades over time.

From a computer technology standpoint, these limitations mean that the processor, memory, and communication interfaces are not orchestrated to optimize data flow and model interaction. There is no tightly integrated pipeline in which: (i) heterogeneous user activity data is normalized and transformed into behavioral feature values, (ii) an attribute set representing the user's informational persona is constructed and updated, (iii) external candidate information is evaluated against this persona using similarity metrics, and (iv) highly contextual prompt sentences are generated for the generative AI model based on this analysis. Thus, there is a need for a technical mechanism that improves how a server acquires, analyzes, and uses user activity data to generate and deliver user-tailored information, thereby improving the overall efficiency and effectiveness of computer-based information processing in such systems.

The specific processing by the specific processing unit 290 of the data processing device 12 in Application Example 1 is realized by the following means.

The present invention provides a server comprising a processor and a memory, the processor being configured to acquire, via a communication interface, heterogeneous information related to a user's daily information activities from a terminal, including at least character-based input information, information resource viewing information, and posting information on an information sharing platform, to obtain structured information corresponding to information resources associated with the acquired information by executing an information acquisition program, and to store the acquired information and the structured information in the memory; to execute an information analysis program that performs preprocessing, feature extraction, and classification processing on information stored in the memory in order to calculate behavioral feature values representing, for each user, an information interest level, an information usage tendency, and an information activity pattern, and to generate, based on the behavioral feature values, an attribute set representing an informational persona of the user; to calculate feature values, by executing the information analysis program, for candidate information obtained from an external information supply platform, to calculate a similarity between the candidate information and the attribute set, to perform selection and ranking of the candidate information based on the similarity, and to determine an information candidate group to be provided to the user; to generate, based on the attribute set and the information candidate group, a prompt sentence that specifies at least one of the user's information interest, expression style, and desired information format, and to generate control information that causes a generative AI model to receive the prompt sentence as input; and to acquire generated information output by the generative AI model in response to the prompt sentence, to store the generated information in association with the user in the memory, and to transmit the generated information to the terminal. This enables the server to technically improve personalization performance by constructing and updating a machine-usable attribute set that captures the user's informational persona, by computationally selecting and ranking external candidate information using similarity measures against the attribute set, and by generating prompt sentences that are adaptively tailored to the persona and the candidate information, thereby causing the generative AI model to produce highly relevant responses and allowing the system to iteratively refine its internal models based on user feedback, improving overall efficiency and effectiveness of computer-based information processing.

The term “processor” refers to a hardware computing element, such as a central processing unit or a processing core, that executes instructions of one or more programs to perform arithmetic, logical, control, and input/output operations in the system.

The term “memory” refers to a hardware storage resource, such as volatile memory or non-volatile memory, that stores programs, data, attribute sets, activity histories, generated information, and other information used and updated by the processor.

The term “communication interface” refers to a hardware and software interface, such as a network interface card and associated communication stack, that enables data transmission and reception between the server and an external device, including a terminal or an external information supply platform.

The term “terminal” refers to an information processing device, such as a portable terminal, a personal computer, or another user-operated device, that communicates with the server via the communication interface and that presents information to a user and acquires user input.

The term “user's daily information activities” refers to a set of digital behaviors of a user, including at least character-based input operations, information resource viewing operations, and posting operations performed on an information sharing platform.

The term “character-based input information” refers to information composed of text input by the user, such as messages, queries, comments, memos, or other textual content entered through an input interface of the terminal.

The term “information resource viewing information” refers to information indicating access by the user to an information resource, including at least resource identifiers, access times, and optionally titles or brief descriptions of the information resources.

The term “posting information on an information sharing platform” refers to information representing content generated or shared by the user on a network-based sharing service, including posts, comments, replies, or similar contributions.

The term “information resource” refers to any digital content unit accessible over a communication network, including at least documents, web pages, articles, media items, or other structured or unstructured data objects.

The term “structured information” refers to information that has been converted into a machine-usable representation having a defined structure, such as fields, tags, or elements extracted from an information resource, including titles, main content segments, metadata, or classification labels.

The term “information acquisition program” refers to a software component executed by the processor that accesses information resources, parses or analyzes those resources, and generates structured information corresponding to at least part of the resources.

The term “information analysis program” refers to a software component executed by the processor that performs preprocessing, feature extraction, classification processing, statistical learning, or machine learning on stored information to compute feature values, behavioral feature values, similarities, and attribute sets.

The term “preprocessing” refers to a set of operations applied to raw data, including at least cleaning, normalization, filtering, or transformation, to convert the raw data into a form suitable for subsequent feature extraction and analysis.

The term “feature extraction” refers to a process by which the processor converts information items into numerical or symbolic feature values that capture relevant characteristics of the information for analysis, comparison, or classification.

The term “classification processing” refers to a process in which the processor assigns one or more categories, labels, or classes to an information item based on its feature values, using predetermined rules or trained models.

The term “behavioral feature values” refers to numerical or symbolic indicators derived from analysis of a user's information activity history, representing at least the user's information interest level, information usage tendency, and information activity pattern.

The term “information interest level” refers to an indicator associated with a user that represents how strongly the user tends to engage with information related to particular topics, domains, or categories.

The term “information usage tendency” refers to an indicator associated with a user that represents patterns of how the user typically consumes information, including at least preferred content types, lengths, or interaction behaviors.

The term “information activity pattern” refers to a temporal or contextual pattern characterizing the user's information activities, including at least frequency, timing, or sequence of accesses to information resources or postings.

The term “attribute set” refers to a collection of attributes, parameters, or values generated for a user based on behavioral feature values, and representing an informational persona of the user, including interest-related attributes, style-related attributes, and format-related attributes.

The term “informational persona” refers to a logical representation of a user's information-related characteristics, constructed from behavioral feature values, that models the user's likely interests, preferences, and interaction styles for use in information processing.

The term “external information supply platform” refers to a network-accessible system, service, or repository that provides candidate information items, such as documents, news items, articles, or other content, to the server via the communication interface.

The term “candidate information” refers to an information item obtained from the external information supply platform that is subject to analysis, similarity computation, selection, and ranking for potential provision to the user.

The term “information candidate group” refers to a plurality of candidate information items selected and ranked by the processor based on similarity to the attribute set, and designated as information to be considered for provision to the user.

The term “similarity” refers to a value or measure computed between feature values of candidate information and an attribute set, indicating the degree of correspondence or relatedness between the candidate information and the user's informational persona.

The term “prompt sentence” refers to a text string or text sequence that specifies at least one of a user's information interest, expression style, and desired information format, and that is supplied as input to a generative AI model to cause generation of information tailored to the user.

The term “control information” refers to information generated by the processor that instructs or configures a generative AI model to receive the prompt sentence as input and to perform generation processing in accordance with one or more specified parameters.

The term “generative AI model” refers to a machine-learned model configured to generate textual or other output content in response to an input prompt sentence, based on learned parameters and internal representations obtained through training on data.

The term “generated information” refers to information output by the generative AI model in response to a prompt sentence, including at least textual responses tailored to the user's informational persona and the information candidate group.

The term “information activity history” refers to a set of stored records relating to a user's past information activities, including at least character-based input information, information resource viewing information, posting information, and optionally usage history information.

The term “usage history information” refers to information representing operations performed by the user on generated information, including at least viewing operations, selection operations, and rejection operations, which are stored as part of the information activity history.

The term “viewing operation” refers to an operation in which the user causes generated information to be displayed or opened on the terminal, indicating at least passive consumption of that information.

The term “selection operation” refers to an operation in which the user explicitly chooses or confirms generated information, such as by clicking, tapping, saving, or otherwise indicating interest or approval.

The term “rejection operation” refers to an operation in which the user expresses disinterest or dismissal of generated information, such as by closing, skipping, hiding, or negatively rating the generated information.

The term “update” refers to a process in which the processor modifies stored behavioral feature values, attribute sets, or other parameters based on newly acquired information activity history, thereby revising or refining the informational persona.

The term “improve, in a successive manner” refers to repeatedly adjusting, over multiple iterations, at least the construction of the prompt sentence and the operation of the generative AI model based on updated attribute sets, so that personalization accuracy and processing efficiency increase over time.

In one embodiment, a server cooperates with at least one terminal operated by a user to provide personalized information using a generative AI model. The server includes a processor, a memory, a communication interface, and persistent storage such as a magnetic disk or solid-state drive. The terminal includes a processor, a memory, an input device, a display device, and a communication interface. The server and the terminal are connected via a communication network such as the Internet, through which digital activity data and generated information are exchanged.

The server stores in the memory and the persistent storage multiple software modules implemented, for example, in a high-level programming language. In one concrete implementation, the server uses an operating system such as a UNIX-like operating system, a web framework such as a general-purpose HTTP application framework, a data analysis library such as a table-based data manipulation library, and a machine learning library such as a general-purpose machine learning toolkit. The server further uses a web data acquisition library similar to an HTML parser and a browser automation framework similar to a headless browser controller, a relational database management system such as a SQL-based database, and a key-value store such as an in-memory cache. The generative AI model is implemented as a neural network accessible via an application programming interface provided by a model serving infrastructure.

The terminal executes an application, such as a web browser or a native application, that records a user's digital activities. The terminal records at least character-based input data, browsing data, and posting data. The character-based input data includes, for example, text strings that the user types in message fields, search boxes, memo editors, or comment fields. The browsing data includes resource identifiers such as uniform resource locators, associated timestamps, and metadata such as page titles acquired from the visited resources. The posting data includes text bodies and associated metadata for posts or comments that the user submits in an information sharing service.

The terminal stores such activity data in a local buffer and periodically sends batches of activity records to the server through the communication interface, using a message format such as a structured text-based serialization. The terminal appends user identifiers or session identifiers to each record so that the server can associate the activity with the corresponding user. By batching and compressing the activity records, the terminal reduces the number of network round trips and the overall communication overhead.

The server receives the activity data and writes it into the relational database using predefined schemas. For example, the server stores each browsing event as one row in a “browsing_log” table, including columns for user identifier, URL, timestamp, and device type. The server stores each posting event as one row in a “posting_log” table, including columns for user identifier, text body, topic tags, and reaction counts. By normalizing the raw activity data into relational tables, the server improves data management and enables index-based retrieval for subsequent analysis, which reduces processing time compared to scanning raw log files.

The server uses the HTML parser and the browser automation framework to enrich the browsing data. The server launches a headless browser instance and loads each URL for which content has not yet been extracted. The server executes rendering until the document object model is stable, and then acquires the HTML source. The server uses the HTML parser to locate structural elements such as title tags, header tags, article containers, and metadata tags. The server extracts a main text segment, a title string, and one or more keyword strings, and stores these as structured columns in an “article_content” table linked to the original browsing_log via a foreign key. This structured representation allows the server to treat long-form content, short news, and static pages in a unified manner.

The server executes an information analysis program that loads batches of user-related records from the database into table-like in-memory structures. The server applies preprocessing operations such as lowercasing, removal of markup tags, and tokenization. The server may further perform stop-word removal and, in some embodiments, stemming or lemmatization. These operations convert heterogeneous text into a normalized token sequence, which reduces sparsity in subsequent feature extraction and improves the stability of the learned representations.

The server performs feature extraction by applying a vectorization algorithm such as term-frequency-inverse-document-frequency. The server maps each text (for example, a page title or a post body) to a high-dimensional numerical vector whose components correspond to weighted token occurrences. As an alternative, the server may use word embedding or sentence embedding models to convert each text to a dense vector. The server stores these feature vectors in a separate feature store or in compressed form in the database. By storing numerical feature vectors, the server can reuse them across multiple analysis cycles without recomputing them from raw text, thereby reducing computational load and latency.

The server computes behavioral feature values for each user by aggregating the feature vectors. The server groups texts by user identifier and time window, and computes statistics such as mean vectors, topic distributions, and content-length distributions. The server may apply an unsupervised clustering algorithm such as k-means clustering or a topic model such as latent Dirichlet allocation over the document vectors to identify latent topics. The server assigns topic probabilities to each document and aggregates the probabilities per user to generate a topic preference vector. The server also computes temporal patterns such as the frequency of access to specific topics in daily or weekly intervals, and derives features that represent recency and trend (for example, exponentially decayed counts). These behavioral feature values characterize, with high resolution, the user's information interest level, information usage tendency, and information activity pattern.

The server generates an attribute set for each user by selecting and encoding such behavioral feature values. The attribute set may be represented as a key-value structure, where keys correspond to semantic attributes (for example, “environmental_interest_score,” “preferred_summary_length,” “technical_depth_preference”), and values are numeric or categorical. The server may compute such values using decision rules or learned models, for example by mapping the topic preference vector and usage statistics to discrete categories. The attribute set functions as an informational persona, and is stored in an “user_persona” table or a dedicated user profile store. By separating the persona from raw activity logs, the server reduces the volume of data that must be accessed during content selection and prompt generation, thereby improving response speed.

The server acquires candidate information from one or more external information supply platforms. The server sends a query via the communication interface, receives lists of recent items, and stores the basic fields (identifiers, titles, summaries, topics) in a “candidate_items” table. The server applies the same preprocessing and feature extraction as applied to user texts, obtaining feature vectors for each candidate item. The server then calculates similarity scores between the user's persona vector and each candidate item vector, using a metric such as cosine similarity. In some embodiments, the server may use a learned similarity model that maps user attributes and item attributes into a joint embedding space. The server ranks the candidate items according to the similarity scores and selects an information candidate group, for example the top N items exceeding a similarity threshold. By restricting downstream processing to this candidate group, the server reduces both data volume and computation needed in the generative pipeline.

The server constructs a prompt sentence for the generative AI model using the attribute set and the information candidate group. The server generates a textual description of the user's interests and preferences, selects representative candidate item titles or short summaries, and composes a prompt sentence that instructs how the generative AI model should generate content. For example, when the user shows a strong interest in environmental issues, the server may generate a prompt sentence such as:
“The user is highly interested in environmental issues, climate change, and renewable energy policy. The user prefers concise, informative explanations. Based on the following recent article headlines and summaries, generate a personalized briefing that this user is likely to find useful.”

In another example, when the user has a mixed interest in artificial intelligence and environmental technology, the server may generate a prompt sentence such as:
“The user often reads about artificial intelligence and green technology. Please generate an overview of recent innovations at the intersection of AI and environmental protection, including 3-5 concrete examples of AI being used to address climate change, pollution monitoring, or energy efficiency.”

In yet another example, when the user prefers bullet-point summaries, the server may generate a prompt sentence such as:
“The user prefers concise bullet-point summaries and is very interested in environmental issues. Summarize today's top 3 environmental news stories in bullet points, with each item including: (1) a headline, (2) a one-sentence summary, and (3) one bullet on why it matters.”

The server translates the attribute set into concrete instructions, such as word limit, tone, format (paragraphs versus bullet points), and level of technical detail. This translation follows non-trivial rules that link numeric feature values (for example, average reading length, typical session duration) to human-readable prompt constraints. For instance, when the average reading length is low and session duration is short, the server automatically constrains the maximum number of paragraphs and enforces bullet-point formatting. These rules are specific to machine-oriented representation of user behavior and are not directly derivable from manual configuration, thereby enabling automated adaptation at a granularity that is impractical for human operators.

The server provides the constructed prompt sentence to the generative AI model. The generative AI model, in one embodiment, is a multi-layer transformer-based neural network. The model includes an embedding layer, multiple self-attention layers, feed-forward sublayers, and a final output projection to a token vocabulary. During training, the model has been optimized using a large text corpus and an objective such as next-token prediction with a cross-entropy loss function. The weights of the attention mechanisms and feed-forward networks are updated using gradient-based optimization such as stochastic gradient descent with variants like Adam. The model may be further fine-tuned on instruction-following data so that it produces coherent outputs in response to instruction-like prompts.

The server sends the prompt sentence as the input token sequence to the generative AI model via an API. The server specifies parameters such as temperature, top-k or top-p sampling thresholds, and a maximum number of output tokens. These parameters control the stochastic sampling behavior of the output distribution. By tuning such parameters based on the user's persona (for example, using a lower temperature for users who prefer deterministic summaries and a higher temperature for users who prefer creative content), the server controls the trade-off between diversity and reproducibility of responses. This adaptation provides a technical improvement over static model usage because it allows the generative model to operate under user-specific constraints without retraining.

The server receives the generated information from the generative AI model as a sequence of tokens, decodes the tokens into a character string, and applies formatting based on the structure requested in the prompt sentence. The server may insert markup representing sections, bullet lists, and emphasis markers to facilitate rendering on the terminal. The server stores the generated information in association with the user identifier, along with metadata such as the prompt identifier, timestamp, and model configuration parameters. The server also maintains indexes over the stored generated information so that it can be retrieved and re-used, reducing repeated calls to the generative AI model and thus decreasing latency and external communication load.

The terminal receives the generated information via the communication interface and displays it on the display device. The terminal renders text in a layout consistent with the requested style (for example, a card-based list of bullet-point summaries). The terminal records user actions such as viewing, scrolling, clicking links, bookmarking items, or dismissing items. These actions are encoded as usage history information. The terminal tags each usage event with identifiers linking it to the corresponding generated content, which allows the server to evaluate which prompts and which candidate selection strategies lead to effective user engagement.

The server receives usage history information from the terminal and writes it into an “interaction_log” table. The server integrates this new information into the information activity history and recomputes behavioral feature values. For example, when the user frequently dismisses long-form articles on a topic but consistently reads short summaries, the server lowers the weight of long-form items in similarity-based ranking and adjusts the attribute corresponding to preferred length. When the user repeatedly interacts with content generated from prompts that emphasize certain subtopics, the server increases the associated interest scores in the persona. This feedback loop is realized by explicit computations on feature vectors and update rules, rather than by simple counters or thresholds. The server may use supervised or reinforcement-learning-inspired updates where engagement indicators serve as reward signals that modify mapping functions from raw features to persona attributes.

By implementing the above data structures and processing flows, the server improves computer technology in multiple ways. First, the server reduces the volume of information that must be transmitted and processed by transforming raw heterogeneous activity logs into compact attribute sets and feature vectors. This reduces database I/O, main memory usage, and CPU cycles for repeated text analysis. Second, the server improves processing speed by performing similarity-based pre-filtering before invoking the generative AI model, thereby limiting model calls to only the most relevant candidate groups and decreasing average response time. Third, the server improves personalization accuracy by leveraging learned behavioral feature values and feedback-driven updates, which reduce mismatches between generated content and actual user preferences. Fourth, the server improves computational efficiency by caching feature vectors and generated outputs, and by reusing persona representations, which lowers repeated computations and external model invocations.

The server operates according to non-conventional rules and data flows that differ from simple automation of human curation. A human curator might manually select articles based on intuition or static tags and write summaries on demand. In contrast, the server executes algorithmic steps that are specific to machine computation: it vectorizes text into high-dimensional feature spaces, applies clustering or topic modeling algorithms, calculates similarity metrics, maintains continuously updated attribute sets, and constructs prompt sentences by rule-based translation from numeric features to textual instructions. The generative AI model internally uses self-attention mechanisms to compute context-dependent token representations, which cannot be replicated by human short-term memory or manual processing for large numbers of users in real time. These technical mechanisms yield a system in which the combination of feature-based candidate selection and persona-based prompt control provides improvements in speed, precision, and efficiency beyond mere automation of existing human workflows.

The system can have multiple alternative embodiments. In one alternative, the server uses a recurrent neural network or a convolution-based model rather than a transformer-based model as the generative AI model. In another embodiment, the server uses different feature extraction methods, such as character n-grams, subword units, or graph-based representations, while still computing similarity between user personas and candidate items. In yet another embodiment, the server aggregates data from multiple terminals belonging to the same user, and the attribute set integrates behavioral feature values across devices. In some embodiments, the terminal performs part of the preprocessing, such as local tokenization or local summarization of long texts, reducing network load and server-side computation.

The terminal may also provide configuration interfaces through which the user can optionally adjust certain parameters, such as the level of detail or the preferred tone, which the server encodes as additional attributes in the persona. However, even without explicit configuration, the server can infer such preferences through analysis of the information activity history and usage history information. This autonomous derivation of preferences based on machine-readable signals contributes to a more scalable and adaptable personalization architecture.

Through these embodiments, the server, the terminal, and the user cooperate to realize a system in which heterogeneous digital activity data is transformed into a structured persona representation, which then guides similarity-based candidate selection and persona-adaptive prompt sentence construction for a generative AI model. As a result, the system achieves technical effects such as improved response time, reduced communication overhead, higher relevance of generated information, and better utilization of computing resources, thereby improving computer-centered information processing beyond a mere abstract idea or conventional workflow.

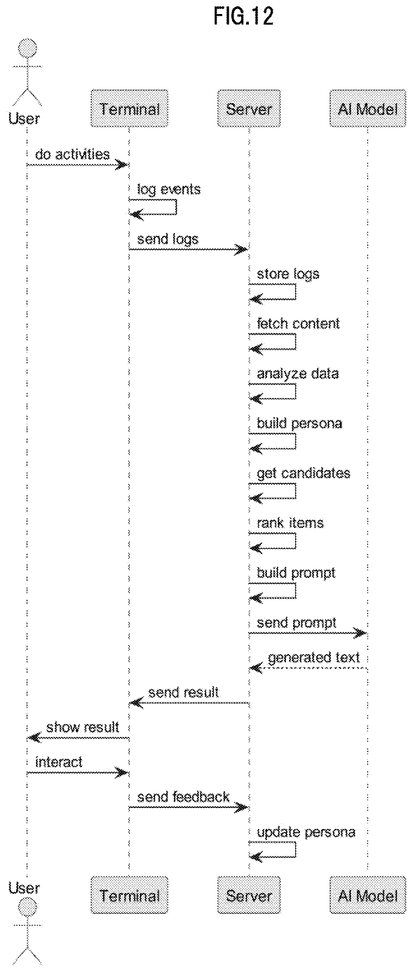

The following describes the processing flow using FIG. 12.

### Step 1:

The user operates the terminal to perform daily digital activities. The user inputs text in message fields, search boxes, memo editors, and comment forms, browses information resources such as web pages and articles, and posts content on information sharing platforms. The input of this step is user actions (keystrokes, clicks, navigation events), and the output is raw activity signals that the terminal can log as character-based input data, browsing data, and posting data.

### Step 2:

The terminal records the user's digital activities as structured log entries. The terminal converts raw activity signals into records including at least a user identifier, timestamps, resource identifiers, text contents, and context metadata (for example, application type and device type). The input of this step is the raw activity signals from Step 1, and the output is a set of structured log records temporarily stored in a local buffer or local storage on the terminal.

### Step 3:

The terminal transmits batches of activity logs to the server via a communication interface. The terminal packages multiple log records in a text-based serialized format, optionally compresses the payload, and sends the payload over a network protocol such as HTTPS. The input of this step is the buffered log records from Step 2, and the output is one or more network messages containing the structured logs that arrive at the server.

### Step 4:

The server receives the activity logs from the terminal and writes them into a persistent database. The server parses the incoming messages, validates the schema and the user identifiers, and inserts each log record into appropriate tables such as “browsing_log,” “input_log,” and “posting_log.” The input of this step is the transmitted log messages from Step 3, and the output is normalized activity rows stored in database tables indexed by user identifier and timestamp.

### Step 5:

The server enriches the browsing data by acquiring structured information from external information resources. The server reads URLs from the “browsing_log” table that lack associated content, uses a browser automation framework to load each URL, and uses an HTML parser to extract titles, main body text, and metadata tags from the rendered pages. The input of this step is a list of URLs and their associated browsing records from Step 4, and the output is structured content records (title, body, keywords, metadata) stored in an “article_content” table linked to the browsing logs.

### Step 6:

The server preprocesses textual data for analysis. The server loads text fields from the activity tables and the article_content table into in-memory data structures, converts characters to a uniform encoding, normalizes case, removes markup tags, and tokenizes the text into word units or subword units. The server may also remove stop words and apply stemming or lemmatization. The input of this step is raw text data stored in the database from Steps 4 and 5, and the output is normalized token sequences suitable for feature extraction.

### Step 7:

The server performs feature extraction to convert text into numerical representations. The server applies a vectorization method such as term-frequency-inverse-document-frequency or embedding-based encoding to the token sequences, producing feature vectors where each dimension corresponds to a token weight or embedding component. The input of this step is the normalized token sequences from Step 6, and the output is a set of numerical feature vectors associated with each text item and user identifier.

### Step 8:

The server calculates behavioral feature values for each user. The server groups feature vectors by user identifier and time range, computes aggregated vectors (such as mean or weighted mean), and applies clustering or topic modeling algorithms to derive topic distributions and usage statistics. The server calculates metrics such as topic preference scores, recency-weighted counts, and preferred content length. The input of this step is the text feature vectors from Step 7, and the output is a collection of behavioral feature values that quantify the user's information interest level, information usage tendency, and information activity pattern.

### Step 9:

The server generates an attribute set representing an informational persona of the user. The server maps the behavioral feature values into a structured profile by assigning attributes such as primary topics of interest, secondary topics, preferred presentation style, and typical detail level. The server encodes these attributes as key-value pairs or a similar structured representation and stores them in a persona profile data structure. The input of this step is the behavioral feature values from Step 8, and the output is an attribute set that functions as the user's informational persona.

### Step 10:

The server acquires candidate information from an external information supply platform. The server sends queries to one or more external content services, receives lists of recent or relevant content items, and stores identifiers, titles, summaries, and metadata for each item in a “candidate_items” table. The input of this step is a request condition (for example, time range or general topics), and the output is a collection of candidate information records available for further analysis.

### Step 11:

The server computes feature vectors and similarity scores for the candidate information. The server preprocesses and vectorizes the titles and summaries of candidate items using the same methods as used for user data, and then calculates similarity measures (such as cosine similarity) between each candidate item vector and the user's persona-related vectors. The input of this step is the attribute set from Step 9 and the candidate item records from Step 10, and the output is a list of candidate items each annotated with a similarity score relative to the user's persona.

### Step 12:

The server selects and ranks an information candidate group for the user. The server sorts the candidate items by similarity score, applies thresholds or top-N selection rules, and filters out items that do not meet predefined criteria (for example, content length or freshness). The input of this step is the similarity-annotated candidate item list from Step 11, and the output is a ranked information candidate group designated for potential presentation to the user.

### Step 13:

The server constructs a prompt sentence for a generative AI model based on the attribute set and the information candidate group. The server reads the user's persona attributes, selects representative candidate titles or brief summaries, and composes a natural-language instruction that encodes user interests, preferred style, and desired output format. For example, the server may generate a prompt sentence such as: “The user is highly interested in environmental issues, climate change, and renewable energy policy. The user prefers concise, informative explanations. Based on the following recent article headlines and summaries, generate a personalized briefing that this user is likely to find useful.” The input of this step is the attribute set from Step 9 and the ranked candidate group from Step 12, and the output is a prompt sentence text and associated control parameters ready for submission to the generative AI model.

### Step 14:

The server invokes the generative AI model with the constructed prompt sentence. The server encodes the prompt sentence into tokens, sets generation parameters such as maximum token count and sampling temperature, and sends a request to the model serving environment. The input of this step is the prompt sentence and control parameters from Step 13, and the output is a generated token sequence representing personalized information content produced by the generative AI model.

### Step 15:

The server decodes and formats the generated information for delivery. The server converts the token sequence into readable text, segments the content into sections or bullet points according to the requested format, and attaches metadata such as topic labels and timestamps. The server stores the formatted generated information in association with the corresponding user identifier in persistent storage. The input of this step is the raw generated token sequence from Step 14, and the output is a fully formatted generated information object suitable for transmission to the terminal.

### Step 16:

The server transmits the generated information to the terminal. The server packages the generated text and metadata into a structured response, sends the response over the communication interface using a protocol such as HTTPS, and ensures delivery to the requesting terminal. The input of this step is the formatted generated information from Step 15, and the output is a network response message that the terminal receives and can render for the user.

### Step 17:

The terminal receives and displays the generated information. The terminal parses the response, extracts the generated text and associated metadata, and renders the content on the display device in a layout consistent with the specified format (for example, headings and bullet lists). The input of this step is the network response from Step 16, and the output is a visual presentation of personalized information on the terminal screen, accessible to the user.

### Step 18:

The user interacts with the displayed generated information. The user performs actions such as reading, scrolling, selecting particular items, following links, bookmarking, or dismissing content. The input of this step is the displayed content from Step 17, and the output is user interaction signals that indicate the user's engagement or disinterest with respect to specific parts of the generated information.

### Step 19:

The terminal records usage history information based on the user's interactions. The terminal converts interaction signals (for example, button clicks, dwell times, scroll depth) into structured records including user identifier, content identifier, operation type (viewing, selection, rejection), and timestamp. The input of this step is the interaction signals from Step 18, and the output is a set of usage history records buffered on the terminal.

### Step 20:

The terminal transmits the usage history records to the server. The terminal batches the records, formats them as structured messages, and sends them through the communication interface to the server for analysis. The input of this step is the buffered usage history from Step 19, and the output is network messages containing usage history information that arrive at the server.

### Step 21:

The server integrates the usage history into the information activity history and updates the persona. The server writes the received interaction records into an “interaction_log” table, merges them with prior activity logs, and recomputes behavioral feature values to reflect the user's responses to generated content. The server adjusts attributes such as topic interest weights and preferred presentation styles in the attribute set. The input of this step is the usage history messages from Step 20, and the output is an updated information activity history and a revised attribute set for the user's informational persona.

### Step 22:

The server adapts future candidate selection and prompt sentence generation based on the updated persona. The server modifies similarity computation thresholds, ranking rules, and format selection logic so that subsequent candidate groups and prompt sentences better align with the user's demonstrated preferences. The input of this step is the revised attribute set from Step 21, and the output is updated internal parameters and rules that will be applied in future executions of Steps 10 through 15 to improve personalization quality and computational efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern digital communication environments, computing systems are increasingly required to support automated interaction that closely reflects an individual user's communication style, linguistic preferences, and emotional expression. Conventional systems that perform user modeling and automatic response generation often rely on manually defined rules, coarse user profiles, or generic language models. As a result, such systems typically produce responses that are stylistically inconsistent, lack personalization, and fail to accurately mimic a particular user's informational individuality and dialog style.

From a computer-technology perspective, existing architectures exhibit several technical shortcomings. First, processing pipelines frequently handle user activity logs, natural language preprocessing, feature extraction, model training, and prompt construction as loosely connected or manual operations, which leads to inefficient use of computational resources and complicates system integration. Second, generic generative AI models are usually invoked without structured, machine-generated prompt sentences that embed fine-grained user-specific features; this causes suboptimal conditioning of the generative AI model, reduces controllability of generated outputs, and degrades the system's ability to consistently reproduce user-specific linguistic behavior. Third, conventional systems do not adequately couple long-term storage of prompt sentences and generated responses with incremental updates of user feature profiles and persona models, which limits the system's ability to adapt to temporal changes in the user's behavior and to improve model quality over time.

Furthermore, existing systems often treat the generation of user-like responses as a purely application-level function, rather than as a coordinated sequence of computational operations designed to optimize data flow, model utilization, and prompt construction. This results in redundant processing, increased latency, and unstable response quality. In particular, there is insufficient technical integration between (i) low-level text preprocessing and feature extraction, (ii) training of user-specific digital persona models, and (iii) automatic generation of structured prompt sentences that are specifically tailored to guide a generative AI model. Accordingly, there is a need for an improved computer-implemented system that: (i) acquires and preprocesses user activity data in a systematic and machine-efficient manner; (ii) automatically derives feature profiles that capture user-specific word usage tendencies, emotional expression tendencies, and sentence structure tendencies; (iii) constructs and maintains a digital persona model that can be used both independently and in combination with a generative AI model; and (iv) automatically generates and manages prompt sentences that accurately instruct a generative AI model to produce responses reflecting the user's informational individuality and dialog style. Such a system should also support incremental learning based on stored prompt sentences and response sentences, thereby improving technical performance, response consistency, and adaptability over time.

The specific processing by the specific processing unit 290 of the data processing device 12 in Example 2 is realized by the following means.

The present invention provides a server comprising a processor configured to acquire activity data relating to information input activities, information browsing activities, and information sharing activities performed by a user via an information processing terminal; preprocess character information included in the activity data by using natural language processing technology to generate analysis data, the preprocessing including tokenizing the character information and removing unnecessary information; extract, from the analysis data, feature quantities indicating a word usage tendency, an emotional expression tendency, and a sentence structure tendency of the user, and generate a feature profile for each user based on the extracted feature quantities; construct a learning model by using machine learning technology based on the feature profile and the analysis data, and generate a digital persona model that imitates an informational individuality and a dialog style of the user; generate a prompt sentence, based on the digital persona model and the feature profile, the prompt sentence being configured to instruct an internal or external generative AI model to generate a response that imitates the word usage tendency, the emotional expression tendency, and a writing style of the user; input the prompt sentence into the generative AI model so as to cause the generative AI model to generate a response sentence reflecting the informational individuality and the dialog style of the user; optionally use the digital persona model to generate a candidate response sentence independently of the generative AI model and select, as a response suitable for the informational individuality of the user, at least one of the candidate response sentence and the response sentence generated by the generative AI model; and store the prompt sentence and the response sentence in association with the user and update the feature profile and the digital persona model based on the stored information so as to perform a learning process that sequentially reflects a change in the informational individuality and the dialog style of the user. This enables an integrated computer-implemented pipeline that efficiently transforms raw user activity data into user-specific feature profiles, digital persona models, and tailored prompt sentences, thereby improving control of generative AI behavior, enhancing personalization and consistency of generated responses, reducing redundant processing, and allowing the system to technically adapt over time to evolving user communication patterns.

The term “activity data” refers to data representing one or more activities performed by a user via an information processing terminal, including at least information input activities, information browsing activities, and information sharing activities, and may include associated metadata such as timestamps, identifiers, and source application types.

The term “information input activities” refers to activities in which a user inputs information into an information processing terminal, including, for example, composing messages, entering text into forms, or creating content through input interfaces.

The term “information browsing activities” refers to activities in which a user browses or views information through an information processing terminal, including, for example, accessing web pages, viewing documents, or reading content provided by information services.

The term “information sharing activities” refers to activities in which a user shares or distributes information via an information processing terminal, including, for example, posting content to communication platforms, sending messages, or sharing media files.

The term “information processing terminal” refers to an electronic apparatus capable of inputting, processing, transmitting, and/or displaying information, including, for example, a portable terminal, a desktop terminal, or any other computing terminal used by a user.

The term “character information” refers to information expressed as a sequence of characters or symbols in a natural language or a structured language, including, for example, text contained in messages, posts, or documents.

The term “natural language processing technology” refers to a set of computational techniques and algorithms for analyzing, transforming, or understanding character information in one or more natural languages, including, for example, tokenization, part-of-speech tagging, and syntactic or semantic analysis.

The term “analysis data” refers to data obtained by preprocessing activity data, including cleaned, normalized, and tokenized character information prepared for subsequent feature extraction and model training.

The term “tokenizing” refers to a process of segmenting character information into smaller units, such as words, subwords, or symbols, which serve as basic elements for subsequent analysis or processing.

The term “unnecessary information” refers to portions of activity data that are not needed for at least one of feature extraction, model training, or response generation, including, for example, redundant formatting, markup, tracking parameters, or noise data.

The term “feature quantities” refers to numerical values, symbolic descriptors, or structured representations that characterize properties of the user's language behavior or communication style, derived from the analysis data.

The term “word usage tendency” refers to a characteristic pattern of a user's selection and frequency of words or phrases, including preferred expressions, commonly used terms, and stylistic word choices.

The term “emotional expression tendency” refers to a characteristic pattern of how a user expresses emotions in language, including, for example, the frequency and context of positive, negative, or neutral expressions.

The term “sentence structure tendency” refers to a characteristic pattern of how a user composes sentences, including, for example, typical sentence lengths, syntactic structures, and use of punctuation.

The term “feature profile” refers to a data structure associated with a user that aggregates feature quantities, including at least word usage tendency, emotional expression tendency, and sentence structure tendency, and is used to characterize the user's informational individuality and dialog style.

The term “learning model” refers to a computational model constructed by using machine learning technology, trained on one or more data sets to learn patterns or relationships, and configured to generate or evaluate data related to user behavior or language.

The term “machine learning technology” refers to techniques and algorithms by which a computing device automatically learns patterns or parameters from data, including, for example, supervised learning, unsupervised learning, or reinforcement learning methods.

The term “digital persona model” refers to a learning model configured to imitate a user's informational individuality and dialog style, and to generate responses or behaviors consistent with the user's characteristic communication patterns.

The term “informational individuality” refers to a set of user-specific characteristics related to information expression and communication, including at least linguistic preferences, emotional expression tendencies, and stylistic patterns.

The term “dialog style” refers to a user-specific manner of conducting dialog, including, for example, typical tone, degree of formality, response length, and interaction patterns.

The term “prompt sentence” refers to a sentence or a set of sentences supplied as input to a generative AI model to instruct or condition the generative AI model to generate output with specified properties, including imitation of a user's word usage tendency, emotional expression tendency, and writing style.

The term “generative AI model” refers to a model implemented by a computing device that is configured to generate data, such as text, images, or other content, in response to input data or conditions, based on learned patterns from training data.

The term “internal generative AI model” refers to a generative AI model that is executed within a computing environment controlled by the system, such as within a local server or data center.

The term “external generative AI model” refers to a generative AI model that is provided by an external service or executed in an external computing environment accessible over a communication network.

The term “response sentence” refers to a sentence or collection of sentences generated in response to an input sentence or context, intended to function as a reply in a dialog or communication scenario.

The term “candidate response sentence” refers to a response sentence generated by the digital persona model, which is considered as one option among multiple possible responses to a given input.

The term “input sentence” refers to a sentence provided to the system by a user or a third party, for which the system is configured to generate a response sentence.

The term “third party” refers to an entity other than the user for whom the digital persona model is generated, including, for example, another user or an external communication partner.

The term “store” refers to the act of recording data in a storage medium or storage system so that the data can be subsequently retrieved, updated, or processed.

The term “learning process” refers to a process in which a processor updates parameters of a learning model or a digital persona model based on new data, such as stored prompt sentences and response sentences, thereby adjusting the model to reflect changes in user behavior or communication patterns.

The term “server” refers to a computing device or a set of computing devices configured to provide processing, storage, and communication functions for implementing at least part of the system, including execution of the processor functions described in the claims.

In one embodiment, a server cooperates with one or more terminals used by a user to implement a system that generates a digital persona model and a prompt sentence for controlling a generative AI model. The server includes at least one processor, a main memory, a non-transitory storage device, and a network interface. The terminal includes at least one processor, a memory, an input device such as a keyboard or touch panel, and a display unit. The server and the terminal are interconnected via a communication network such as the internet using a protocol such as HTTPS.

The server executes software components implemented, for example, in a programming language such as Python on an operating system such as a general-purpose server operating system. The server may further use a web framework such as a general-purpose web framework, a natural language processing library such as a general-purpose NLP library, and a machine learning framework such as a general-purpose machine learning framework. The server may employ hardware acceleration using a graphics processing unit.

The terminal executes an application program that records user activity data. The terminal acquires character information and associated metadata when the user performs information input activities, information browsing activities, and information sharing activities. For example, when the user enters a message into a messaging application, the terminal records the message text, a timestamp, and an identifier of the communication channel. When the user browses a web page using a web browser, the terminal records a uniform resource locator, a page title, and a timestamp. When the user posts text to an information sharing service, the terminal records the posted text, a timestamp, and a category of the service.

The terminal transmits the recorded activity data to the server in a structured data format such as a hierarchical text-based data format. The terminal may batch multiple activity records into a single request to reduce communication overhead and may perform local buffering of unsent data when network connectivity is limited. This batching and buffering reduce the number of network round trips and improve overall throughput of the system.

The server receives the activity data via the network interface and stores the raw records into a storage subsystem such as a relational database or a document database. The server associates each record with a user identifier and a record type that indicates whether the record corresponds to an information input activity, an information browsing activity, or an information sharing activity. The server stores additional metadata such as timestamps, source application types, and language tags.

The server preprocesses character information contained in the stored activity data using natural language processing technology. The server reads raw text fields and applies normalization, tokenization, and filtering operations. For example, the server normalizes Unicode characters, unifies character width, converts text to a consistent case where appropriate, and removes markup tags and tracking query parameters from URLs using pattern matching and regular expressions. The server then performs tokenizing by segmenting the normalized text into tokens such as words or subwords using a tokenizer module. The server may remove certain tokens considered unnecessary for feature extraction, such as some stop words or specific symbols, according to predefined rules stored in a configuration file.

The server stores the resulting analysis data as a structured representation that associates each original record with its normalized and tokenized form. By creating this intermediate analysis data, the server reduces repeated preprocessing operations, thereby lowering computational cost in downstream modules. The explicit normalization and tokenization pipeline improves the consistency of feature extraction, which leads to more stable and accurate learning of user-specific patterns compared to ad hoc, application-level text handling.

The server extracts feature quantities from the analysis data for each user. The server computes word usage tendencies by counting token frequencies, phrase co-occurrence statistics, and n-gram distributions. The server computes emotional expression tendencies by applying a sentiment analysis classifier implemented as a neural network, for example, a bidirectional encoder architecture, to each text segment, and then aggregating sentiment scores over time. The server computes sentence structure tendencies by measuring average sentence length, dispersion of sentence lengths, and syntactic features such as part-of-speech patterns obtained from a tagger module.

The server encodes these feature quantities into a feature profile data structure for each user. The feature profile may include numerical vectors representing token frequency distributions, scalar values representing average sentiment scores, and categorical attributes representing dominant tone or style (for example, casual vs. formal). The feature profile is stored as a compact record associated with the user identifier. By using aggregated feature quantities rather than raw logs during model training, the server decreases the volume of data that must be repeatedly processed, improving memory usage and training speed.

The server constructs a learning model that serves as a digital persona model. In one embodiment, the server uses a transformer-based neural network architecture as the core of the generative language model. The server initializes the model with parameters of a base language model trained on a large corpus. The neural network may include a plurality of self-attention layers, feed-forward sublayers, and layer normalization units. Each self-attention layer uses multi-head attention with a defined number of attention heads, each head having weight matrices for queries, keys, and values.

The server fine-tunes the base model using the analysis data and the feature profile of the user. The server creates training sequences from the user's preprocessed texts, optionally augmenting them with feature embeddings derived from the feature profile. The server defines a loss function such as cross-entropy loss over next-token predictions. During training, the server computes gradients of the loss with respect to model parameters by backpropagation and updates the parameters using an optimization algorithm such as the Adam optimizer with specified learning rate, momentum terms, and weight decay. The server may use techniques such as mini-batch training, gradient clipping, and learning rate scheduling.

The server optionally performs data augmentation by inserting synthetic variations of user texts that preserve key stylistic features but modify surface forms. For example, the server may replace certain content words with synonyms while preserving function words and sentence length patterns. This augmentation strengthens the model's ability to generalize the user's style beyond exact memorization, improving response diversity without losing persona consistency.

The digital persona model thus obtained is a user-specific model that maps an input text context to a distribution over possible next tokens, biased according to the user's word usage tendency, emotional expression tendency, and sentence structure tendency. The feature profile may be used as additional input to the model, for example, as a conditioning vector concatenated to token embeddings or injected through specialized control tokens. This combination causes the model to generate responses that are statistically closer to the user's historical communication style than those produced by a generic model.

The server generates a prompt sentence for a generative AI model based on the digital persona model and the feature profile. The server executes a prompt generation module that uses template rules and the stored feature quantities to construct natural language instructions. The server, for example, selects representative phrases from the word usage tendency, such as frequently used greetings or expressions of gratitude, and includes them in the prompt sentence. The server may also encode information about preferred response length and tone.

Examples of prompt sentences include the following:
“You are a digital persona that imitates the user's style. The user often says ‘Good morning!’ and ‘Thank you so much’. Respond in a warm, friendly, and concise manner, using similar phrases and keeping most replies under three sentences.”
“You are a digital persona that represents the user. The user tends to be polite and frequently writes ‘I really appreciate it’. Please respond in a polite, positive tone and avoid long, complex sentences unless necessary.”
“You are a digital clone of the user. The user usually greets with ‘Good morning’ and ends messages with ‘See you later’. Generate responses that use similar greetings and closings, and maintain a casual and friendly style.”

By automatically generating these prompt sentences from the learned feature profile rather than relying on manually written instructions, the server achieves a finer and more consistent conditioning of the generative AI model. The server may provide the prompt sentence as a system-level instruction and supply the current input sentence as a user-level message when calling an external generative AI model via an application programming interface.

The server can also use the digital persona model directly, without involving an external generative AI model, to generate a candidate response sentence. In such a case, the server feeds the input sentence into the digital persona model and performs decoding using a method such as greedy search, beam search, or nucleus sampling with specified parameters. The server then obtains one or more candidate response sentences that reflect the user's style learned during fine-tuning.

The server may select between a candidate response sentence generated by the digital persona model and a response sentence generated by the external generative AI model conditioned by the prompt sentence. The server can use a scoring function that compares each candidate response against the feature profile, including metrics such as similarity of token distribution to the user's typical distribution, alignment of sentiment scores with the user's emotional expression tendency, and conformity of length and structure to the user's sentence structure tendency. By choosing the response with the highest compatibility score, the server increases consistency with the user's informational individuality, improving the technical quality of persona emulation.

The server records associations between prompt sentences, input sentences, and generated response sentences in a storage device. For each interaction, the server stores at least a prompt identifier, the prompt text, the input text, the response text, and evaluation metrics such as compatibility scores. Periodically, the server loads accumulated records and updates the feature profile and the digital persona model. For example, the server can recompute feature quantities on a sliding time window to reflect recent changes in the user's style, or fine-tune the digital persona model further using newly collected responses and interactions.

This incremental learning reduces model drift and maintains up-to-date personalization without retraining from scratch on the entire historical dataset. In addition, because the server uses stored prompt-response pairs as structured training examples, the system improves efficiency of data reuse and reduces storage requirements compared to keeping all raw logs. The optimization and selective sampling of stored interactions enable faster convergence of model updates and lower computational load.

The system improves computer technology in several ways. First, the integration of preprocessing, feature extraction, digital persona modeling, and prompt sentence generation into a defined data pipeline reduces redundant computations and avoids repeated analysis of the same raw data. By separating raw activity data, analysis data, feature profiles, and model checkpoints into distinct layers, the server can cache intermediate representations and schedule reprocessing only when necessary. This design improves processing speed and computational efficiency.

Second, the use of explicit feature profiles as conditioning signals for both the digital persona model and the prompt sentence enables more precise control over generated content. This control reduces the number of iterations needed to obtain an acceptable response, thereby decreasing overall processing time and network usage when interacting with external generative AI models. The system thus reduces communication load and improves latency compared to naive repeated prompting.

Third, the server applies specific model training techniques, such as targeted fine-tuning with user-specific data and feature-conditioned generation, which cannot be practically performed by a human. The server performs large-scale gradient-based optimization over high-dimensional parameter spaces with millions or billions of parameters. The resulting improvements in stylistic accuracy, sentiment alignment, and response consistency arise from mathematical optimization and complex neural computations that are not equivalent to simple automation of human judgment.

Fourth, the system uses non-conventional data flow and control logic. Instead of directly feeding user messages to a generic generative AI model, the server interposes a specialized persona modeling stage and a prompt construction stage, and optionally a candidate response scoring stage. These stages implement algorithmic rules and machine-learned transformations that reshape and filter data to better utilize the capabilities of the underlying hardware and models. This non-standard architecture provides a technical effect of improved model controllability and resource utilization.

In another embodiment, the server resides in a distributed computing environment where different modules execute on different physical machines. For example, a preprocessing service runs on a front-end server, a feature extraction service and model training service run on a compute cluster with multiple graphics processing units, and a prompt generation and response selection service runs on an application server. The modules communicate via message queues. This modularization allows horizontal scaling of computationally intensive components and accommodates high volumes of user activity data.

In a further embodiment, the digital persona model is implemented not only as a generative language model but also as a hybrid model that includes a classification sub-network for style conformity checking. The server uses the classification sub-network to evaluate candidate responses and to reject responses that fall outside a defined style boundary. This configuration further reduces the likelihood of style-inconsistent outputs and improves reliability of persona emulation.

In yet another embodiment, the terminal performs part of the preprocessing tasks, such as initial tokenization or local removal of unnecessary information, before transmitting data to the server. This reduces network bandwidth usage and distributes computational load. The terminal may also cache prompt sentences received from the server and reuse them for multiple local interactions with a lightweight generative model running on the terminal when network access to an external model is limited.

Through these embodiments, the server, the terminal, and the user cooperate in a technically structured system that transforms raw digital activities into a digital persona model and prompt sentences optimized for a generative AI model. The explicit and detailed handling of data structures, neural network training, feature extraction, and prompt generation improves computational efficiency, personalization accuracy, and system adaptability. This improvement is rooted in specific computer-implemented techniques rather than in a mere automation of human behavior, thereby yielding concrete technical benefits such as faster processing, reduced resource consumption, and higher-quality, user-specific responses.

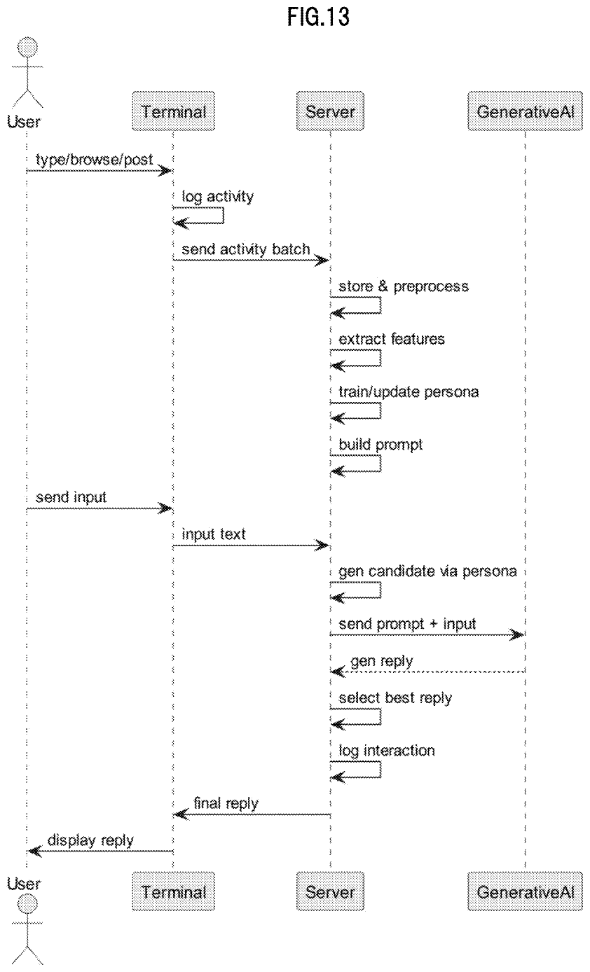

The following describes the processing flow using FIG. 13.

### Step 1:

The user performs information input, information browsing, and information sharing activities via the terminal.

The user inputs text into applications, browses web pages, and posts messages to communication platforms.

The input is user operations such as key presses, touch events, and selection actions.

The output is activity data inside the terminal, including character information, timestamps, identifiers of applications, and URLs.

### Step 2:

The terminal records and structures the activity data.

The terminal converts the raw events from the user into structured records that include fields such as user identifier, activity type, text content, URL, and timestamp.

The input is low-level event logs and content entered or viewed by the user.

The output is structured activity records stored temporarily in a local storage area or memory buffer in the terminal.

### Step 3:

The terminal batches and transmits the activity data to the server.

The terminal groups multiple activity records into a transmission unit, serializes the records into a text-based message, and sends the message to the server over a secure network protocol.

The input is the set of structured activity records stored on the terminal.

The output is a network request containing batched activity data that is delivered to the server.

### Step 4:

The server receives and validates the activity data.

The server accepts the network request, parses the serialized message, verifies authentication tokens, checks data format consistency, and rejects or logs malformed entries.

The input is the batched activity data received over the network.

The output is a set of validated activity records written into a persistent storage device in association with a user identifier and record type.

### Step 5:

The server normalizes and tokenizes the character information.

The server reads stored activity records, normalizes character encoding, unifies case and character width, removes markup or tracking parameters, and segments text into tokens by applying a tokenizer module.

The input is raw text segments extracted from the validated activity records.

The output is analysis data that includes normalized token sequences and cleaned text, stored in association with the corresponding original records.

### Step 6:

The server removes unnecessary information from the analysis data.

The server filters tokens according to predefined rules, discarding tokens that do not contribute to learning, such as specified stop words, certain control characters, and irrelevant symbols, while preserving tokens that indicate style and emotional expression.

The input is tokenized text sequences and associated metadata from the analysis data.

The output is refined token sequences in which unnecessary information has been removed, providing a more compact representation for feature extraction.

### Step 7:

The server extracts feature quantities from the refined token sequences.

The server counts token frequencies, computes n-gram statistics, applies sentiment analysis models to obtain emotional scores, and analyzes sentence length and part-of-speech distributions to derive structural features.

The input is the refined token sequences and sentence boundary information for each user.

The output is a set of numerical and categorical feature quantities representing word usage tendencies, emotional expression tendencies, and sentence structure tendencies for each user.

### Step 8:

The server aggregates feature quantities into a feature profile per user.

The server combines token frequency vectors, sentiment statistics, and structural measures into a unified data structure, and normalizes or scales the values so that they can be used as conditioning inputs to models.

The input is the individual feature quantities computed from multiple activity records of the same user.

The output is a feature profile associated with the user identifier, stored as a compact representation of the user's informational individuality and dialog style.

### Step 9:

The server prepares training data for a digital persona model.

The server selects preprocessed text segments for the user, attaches corresponding feature profile vectors or indicators, and arranges input-output pairs for language modeling, optionally constructing context windows that include conversation history.

The input is the user's analysis data and the user's feature profile.

The output is a training dataset consisting of tokenized sequences with associated feature conditions and targets for next-token prediction.

### Step 10:

The server trains or fine-tunes a learning model as a digital persona model.

The server initializes a neural network with base parameters, performs forward passes on the training dataset, computes loss values such as cross-entropy, calculates gradients by backpropagation, and updates network weights using an optimization algorithm on a processor or an accelerator.

The input is the prepared training dataset and an initial parameter set of the learning model.

The output is an updated parameter set of the learning model that constitutes the digital persona model tailored to the user.

### Step 11:

The server evaluates the trained digital persona model.

The server applies the digital persona model to validation data, generates predicted tokens, compares them to reference tokens, and computes evaluation metrics such as perplexity, accuracy, and style conformity scores based on the feature profile.

The input is the trained parameter set of the digital persona model and a validation subset of the analysis data.

The output is evaluation results and quality indicators used to determine whether the model satisfies predetermined performance thresholds.

### Step 12:

The server stores the digital persona model for subsequent use.

The server writes the trained parameters, model configuration, and associated feature profile identifiers to a non-transitory storage medium, and registers version information and timestamps.

The input is the trained and evaluated digital persona model and its metadata.

The output is a persistent model record that can be loaded later to generate responses or update the persona.

### Step 13:

The server generates a prompt sentence for a generative AI model.

The server reads the feature profile and representative phrases from the user's data, selects typical greetings and stylistic markers, and fills predefined templates to construct a textual instruction that describes the user's style and desired response constraints.

The input is the feature profile of the user and stored information about frequently used expressions.

The output is a prompt sentence that instructs a generative AI model to imitate the user's word usage tendency, emotional expression tendency, and writing style.

### Step 14:

The server optionally refines the prompt sentence based on recent interactions.

The server examines recent prompt-response pairs, adjusts descriptive phrases in the prompt, and updates indications of preferred tone and response length to reflect changes in the user's behavior.

The input is the initially generated prompt sentence and logs of recent interactions for the same user.

The output is an updated prompt sentence that more accurately reflects the current informational individuality and dialog style of the user.

### Step 15:

The server generates a candidate response using the digital persona model.

The server loads the digital persona model, encodes the input sentence from the user or a third party, and performs decoding using a defined search algorithm to obtain a sequence of output tokens that form a candidate response sentence.

The input is an input sentence and the stored digital persona model.

The output is at least one candidate response sentence that follows the user-specific style captured by the model.

### Step 16:

The server generates a response using an external or internal generative AI model with the prompt sentence.

The server composes a request that includes the prompt sentence and the input sentence, sends the request to the generative AI model, receives the generated text, and parses it as a response sentence.

The input is the prompt sentence, an input sentence, and access credentials for the generative AI model.

The output is a response sentence produced by the generative AI model under the conditioning specified by the prompt sentence.

### Step 17:

The server compares and selects a response suitable for the user's informational individuality.

The server computes style compatibility scores for the candidate response sentence and the generative AI model's response sentence by comparing their token distributions, sentiment profiles, and length characteristics against the feature profile.

The input is the candidate response sentence, the generative AI model's response sentence, and the feature profile.

The output is a selected response sentence that best satisfies predetermined criteria for similarity to the user's informational individuality and dialog style.

### Step 18:

The server records the interaction including the prompt sentence and the selected response.

The server stores the prompt sentence, the input sentence, the selected response sentence, and evaluation metrics as a new interaction record in persistent storage.

The input is the selected response sentence, the corresponding prompt sentence, and context information.

The output is an interaction log entry that can be reused for incremental learning and analysis.

### Step 19:

The server updates the feature profile using accumulated interaction logs.

The server periodically retrieves recent interaction records, recalculates feature quantities such as word frequencies and sentiment tendencies, and revises the feature profile so that it reflects recent changes in the user's communication patterns.

The input is a set of stored interaction logs associated with the user.

The output is an updated feature profile that replaces or complements the previous profile for subsequent modeling and prompt generation.

### Step 20:

The server incrementally updates the digital persona model.

The server constructs an additional training dataset from recent interactions, performs further fine-tuning of the digital persona model with a lower learning rate, and updates model parameters while monitoring for overfitting or degradation of generalization.

The input is the current digital persona model and the new training dataset derived from recent interactions.

The output is an incrementally updated digital persona model that more accurately represents the user's evolving informational individuality and dialog style.

### Step 21:

The terminal receives and displays the selected response sentence to the user.

The terminal obtains the selected response from the server, formats the text according to the user interface layout, and renders the response in a dialog screen or application window.

The input is the selected response sentence delivered from the server.

The output is a visual representation of the response on the display device, which the user can read and, if desired, adopt or edit before sending to another party.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In networked information environments, computing systems increasingly attempt to personalize content delivery and automated communication based on user data. Conventional techniques, however, typically rely on simple rule-based filtering or coarse-grained user profiles that are periodically updated but not deeply integrated with the user's language patterns, emotional states, or long-term behavioral tendencies. Such systems suffer from several technical deficiencies.

First, conventional personalization engines mainly operate on static preference vectors or click histories and are not configured to process heterogeneous user activity data streams, such as text input data, browsing data, and posting data of information sharing services, in a unified manner. As a result, the underlying processing architecture cannot fully exploit contextual information and cannot robustly infer the user's informational individuality or nuanced interests, which leads to suboptimal ranking and selection of content items and inefficient resource use in the information processing pipeline.

Second, conventional systems generally do not maintain a structured “digital personality” representation that consistently reflects the user's informational individuality, language pattern, and emotional state over time. In many cases, natural language generation components are invoked with generic prompts or fixed templates, which causes the generative models to produce responses that are weakly aligned with the user's historical behavior and often require repeated calls and heuristic post-processing. This results in unnecessary computation, redundant network traffic, and increased latency in delivering meaningful responses to user terminals.

Third, existing generative systems typically do not employ a feedback loop in which reaction information and feedback information from recipients are reintegrated into the personality representation and the prompt construction logic. Without such adaptive updating, the generative behavior drifts away from the evolving characteristics of the user and the recipients, thereby degrading the quality of automated responses and recommendations and requiring more frequent retraining of models at high computational cost.

Fourth, conventional architectures do not provide a coherent mechanism for reliably maintaining and using a user-specific digital personality after death of the user or during long-term absence of the user. In particular, there is no integrated control flow in which lifetime configuration conditions, posthumous operation policies, generative model invocation, and content selection logic are systematically combined. Consequently, even if preserved content exists, existing systems cannot consistently generate and deliver messages or personalized content that faithfully mimic the user's language pattern and informational individuality in a technically robust and resource-efficient way.

Accordingly, there is a need for an improved computer-implemented system and processing architecture that: (i) unifies acquisition and storage of heterogeneous user activity data; (ii) performs structured natural language processing and feature extraction to derive personality information and emotional state information; (iii) programmatically generates prompt sentences that condition a generative artificial intelligence model on such personality information; (iv) uses the conditioned generative artificial intelligence model both to generate response information and to select and rank external content items as a personalized content set; and (v) continuously updates the personality information and prompt sentences based on reaction information and feedback information, including in scenarios where the user is deceased or absent. Such improvements would concretely enhance the functioning of the information processing apparatus itself by reducing redundant computation, improving the alignment of generated outputs with user characteristics, and enabling more efficient and consistent management of generative model behavior over the lifetime of the system.

The specific processing by the specific processing unit 290 of the data processing device 12 in Application Example 2 is realized by the following means.

The present invention provides a server comprising a processor configured to acquire and store, from a terminal or an external information processing apparatus, information input data, browsing data, and posting data of an information sharing service as daily information activities of a user; to perform information processing including natural language processing on the stored data to execute text normalization, tokenization, and feature extraction, and to extract attribute information regarding an emotional state and interests of the user; to generate personality information representing an informational individuality and a language pattern of the user based on the extracted emotional state and interests, and to generate a prompt sentence for input to a generative artificial intelligence model using the personality information as a condition; to operate the generative artificial intelligence model based on the prompt sentence and the personality information to generate response information or recommendation information that imitates the informational individuality and the emotional state of the user; to select or rank content information acquired from an external information providing service in accordance with the personality information and the emotional state, and to generate a personalized content set; to transmit the generated response information or the personalized content set to the terminal and cause the user or another recipient to be presented with the response information or the personalized content set; to generate and transmit the response information or the personalized content set to the recipient by using the personality information and the generative artificial intelligence model after death of the user or after a long-term absence of the user, based on conditions set during a lifetime of the user; and to acquire reaction information and feedback information from the recipient after transmission, and to update the personality information and contents of the prompt sentence based on the reaction information and the feedback information. This enables the information processing system to internally maintain and refine a user-specific digital personality and associated prompt sentences, to control a generative artificial intelligence model in a manner tightly conditioned on that personality, and thereby to improve computer functionality by providing more accurate and efficient generation of responses and personalized content, reducing redundant computation and network usage, and supporting consistent automated communication even when the user is no longer actively operating the terminal.

The term “user” refers to an individual or entity whose daily information activities are collected, analyzed, and modeled by the system.

The term “terminal” refers to an information processing device used by the user or a recipient, including but not limited to a portable computing device, a stationary computing device, or a head-mounted display, which transmits user activity data to the server and presents generated information to the user or the recipient.

The term “external information processing apparatus” refers to a computing device or service, other than the terminal and the server, that provides user-related data or content data to the server via a communication network.

The term “information input data” refers to data representing text or other information entered by the user into an application, a service, or a device, including but not limited to chat messages, search queries, and form inputs.

The term “browsing data” refers to data indicating content accessed by the user through a communication network, including but not limited to accessed resource identifiers, timestamps, and context information regarding viewed pages or content items.

The term “posting data of an information sharing service” refers to data representing contributions made by the user on a network-based platform, including but not limited to text posts, comments, and messages shared with other users.

The term “daily information activities” refers to a collection of user actions related to information input, browsing, and posting, performed via one or more devices or services over time.

The term “natural language processing” refers to computational processing applied to human language data, including but not limited to text normalization, tokenization, part-of-speech tagging, syntactic analysis, semantic analysis, and conversion of text into numerical features.

The term “text normalization” refers to processing that converts raw text into a standardized form, including but not limited to case normalization, removal of noise characters, and normalization of punctuation and spacing.

The term “tokenization” refers to processing that segments text into smaller units, such as words, subwords, or sentences, for subsequent analysis.

The term “feature extraction” refers to processing that converts text or other data into numerical or symbolic representations that capture characteristics of the data, such as embeddings, frequency counts, or categorical indicators.

The term “attribute information regarding an emotional state” refers to data that represents an inferred psychological or affective state associated with user-generated text or activity, including but not limited to categories such as joy, sadness, anger, or neutrality, and corresponding intensity values.

The term “attribute information regarding interests” refers to data that represents topics, categories, or domains toward which the user exhibits a preference, including but not limited to weights or scores indicating the strength of such preferences.

The term “personality information” refers to structured information representing an informational individuality of the user, including at least language patterns, interests, and emotional tendencies derived from the user's daily information activities.

The term “informational individuality” refers to a set of characteristics that distinguish the user's way of handling and expressing information, including preferred topics, typical reactions, and consistent behavioral patterns in information activities.

The term “language pattern” refers to a characteristic style in which the user composes text, including but not limited to sentence length, choice of words, use of expressions, and habitual phrasing.

The term “prompt sentence” refers to a text instruction or conditional sentence provided as input to a generative artificial intelligence model, which specifies conditions or constraints such as personality information, emotional state, interests, and a type of target task.

The term “generative artificial intelligence model” refers to a computational model configured to generate data, including natural language text, based on an input such as a prompt sentence and optional conditioning information.

The term “response information” refers to generated information produced by the generative artificial intelligence model, in the form of one or more text messages, that is intended to be provided to the user or a recipient as a reply or explanation.

The term “recommendation information” refers to generated information that proposes one or more content items, actions, or options to the user or a recipient, based on the personality information, emotional state, and interests.

The term “external information providing service” refers to a network-based service that supplies content information to the server, including but not limited to news services, media distribution platforms, and information databases.

The term “content information” refers to data representing an individual content item obtainable from an external information providing service, including at least a title, an identifier, and descriptive metadata.

The term “personalized content set” refers to a group of content information elements selected and ordered according to the personality information and the emotional state of the user.

The term “recipient” refers to an individual or entity that receives response information or a personalized content set generated by the server, including the user and persons other than the user.

The term “digital personality” refers to an artificial representation that imitates the user's language pattern, informational individuality, and emotional expression, and that interacts with a recipient by generating dialogue messages.

The term “conditions set during a lifetime of the user” refers to operation settings specified by the user while the user is alive, including but not limited to permissions, target recipients, communication channels, topics, and timing rules for posthumous or absence-based operation of the digital personality.

The term “after death of the user” refers to a period in which the user is no longer alive and can no longer directly operate a terminal or otherwise participate in daily information activities.

The term “long-term absence of the user” refers to a state in which the user does not operate a terminal or does not generate daily information activities for a predetermined period.

The term “reaction information” refers to data indicating how a recipient has interacted with delivered response information or a personalized content set, including but not limited to read status, selection actions, or reply messages.

The term “feedback information” refers to explicit or implicit evaluations supplied by a recipient regarding generated information, including but not limited to ratings, preference signals, or correction messages.

In one or more embodiments, a server, a terminal, and a communication network together implement a system configured to construct and use a digital personality of a user based on heterogeneous daily information activities. The system operates on general-purpose computing hardware, but uses specific data structures, model architectures, and control flows to improve the functioning of the information processing apparatus itself, including improved text processing accuracy, reduced latency in content selection, reduced communication overhead, and more stable control over a generative AI model.

### A. Hardware and Software Configuration

A server includes at least one processor, a main memory, a non-volatile storage device, and a network interface. The processor may be a central processing unit or a graphics processing unit. The memory stores an operating system, a database management system, a set of natural language processing libraries, a machine learning framework, and a generative AI client module. The non-volatile storage device stores a relational database and various model parameters. The network interface connects the server to one or more terminals and to external services via a communication network such as the Internet.

A terminal includes a processor, a memory, a user interface device, and a communication interface. The terminal runs a client application that acquires user input data and displays information received from the server. The terminal may be a mobile communication device, a stationary computing device, or a wearable computing device.

The server uses software components including, but not limited to, a database management system such as a relational database engine, natural language processing libraries such as tokenization and lemmatization modules, and machine learning frameworks such as tensor-based computation libraries. The server employs a generative AI model that may be implemented as a transformer-based neural network, for example a multi-layer attention-based architecture with self-attention and feedforward layers.

### B. Data Structures and Storage

The server defines and maintains specific data structures to manage user-related information. For example, the server maintains a user activity table that stores records of information input data, browsing data, and posting data of information sharing services. Each record includes fields such as user identifier, timestamp, source type, raw text, and context metadata. The server maintains an emotion annotation table that links each activity record to emotion labels and confidence scores. The server maintains a feature table that stores numerical feature vectors computed from each text record, such as embedding vectors or topic vectors.

The server also maintains a personality profile table. The personality profile includes fields representing informational individuality, language pattern parameters, interest vectors, and emotional tendency statistics. The server further maintains a prompt template table. Each entry in the prompt template table stores a base persona description and parameterized placeholders for emotional state, interest category, and task type.

By using these structured tables, the server can perform indexed retrieval and batch processing on large volumes of heterogeneous user data, which improves data access efficiency and reduces unnecessary re-computation of features.

### C. Natural Language Processing and Feature Extraction

The server applies natural language processing to the stored raw text data in order to generate normalized and feature-rich representations. The server uses language processing libraries to perform text normalization, including lowercasing, removal of noise characters, and normalization of punctuation. The server then performs tokenization, splitting text into sentences and tokens. The server may also perform lemmatization and part-of-speech tagging.

The server converts tokens into numerical vectors using an embedding model. In one embodiment, the server uses a pre-trained word or sentence embedding model implemented on top of a machine learning framework. The server stores the resulting vectors in the feature table, referencing the original activity records. Because the server persists these feature vectors, the server can reuse them in multiple downstream processes, such as emotion classification, topic modeling, and similarity computation, without re-running the initial text processing.

The server thereby improves computational efficiency and reduces latency in later stages. A human operator manually reading and classifying the text does not generate reusable vector representations with this level of granularity or consistency, so the described approach is not merely automating human reading but rather reorganizing data into a form optimized for algorithmic processing.

### D. Emotion Estimation and Interest Extraction

The server estimates an emotional state for each text record by applying a trained classifier. In one embodiment, the server uses a multi-layer neural network that receives the embedding vector as input and outputs a probability distribution over emotion categories such as joy, sadness, anger, and neutral. The neural network includes at least an input layer matching the embedding dimension, one or more hidden layers using rectified linear unit activation functions, and an output layer with softmax activation. The server trains this classifier using supervised learning on labeled emotion datasets. The training uses a loss function such as cross-entropy between predicted probabilities and true labels, and weights are updated using gradient descent with backpropagation.

The server aggregates emotion predictions at the user level by computing statistics over time intervals and contexts, such as mean positive emotion ratio per topic, variance of emotional intensity, and correlation between topics and emotion categories. The server stores these aggregated values in the personality profile table.

The server also extracts user interests using topic modeling or clustering. In one embodiment, the server performs topic modeling on the feature vectors using a probabilistic topic model. The server computes topic distributions for each document and aggregates them at the user level to obtain interest vectors. These vectors indicate the probability that the user is interested in each topic domain, such as technology, music, or sports.

By using these structured numerical features and aggregated statistics, the server can more precisely and efficiently represent the user's informational individuality and emotional tendencies than a simple list of liked items, improving both the accuracy and the computational behavior of downstream modules.

### E. Personality Information Generation

The server generates personality information for each user based on the extracted emotional and interest attributes and language patterns. The server analyzes distributions of sentence lengths, frequent phrases, and lexical choices across the user's historical texts. The server may compute histograms of sentence length, frequency counts of particular expressions, and diversity measures of vocabulary usage.

The server consolidates this information into a personality profile that includes: an interest vector, an emotion tendency vector, and language style descriptors such as typical sentence length range, frequency of casual expressions, and presence or absence of certain stylistic markers. The server stores these as numeric parameters and categorical fields in the personality profile table.

This personality profile is designed to be machine-readable and directly usable by prompt generation logic and content selection logic, thereby improving the server's ability to control the behavior of a generative AI model in a consistent and resource-efficient manner.

### F. Generative AI Model Configuration and Prompt Sentence Construction

The server uses a generative AI model to generate response information and recommendation information. In one embodiment, the generative AI model is a transformer-based neural network with multiple encoder-decoder layers or a decoder-only architecture. Each layer includes self-attention mechanisms and position-wise feedforward networks. The model parameters are stored in memory and loaded into the server's machine learning framework for inference.

The server does not modify the core architecture for each user, but instead conditions the model behavior by providing structured prompt sentences that encode personality information and task-specific constraints. The server constructs a base persona prompt sentence that describes the user's personality in natural language. For example, the server may generate a base prompt sentence such as:
“You are the digital personality of a user who writes short, friendly messages, often with light humor, and who is highly interested in technology and jazz music, and typically expresses an optimistic tone.”

The server then constructs a task-specific prompt sentence by appending or inserting context information, such as emotional state, content domain, and target operation. For example, the server may generate:
“Based on the user's current emotion ‘tired’ and their interest in relaxing music and comedies, generate three content recommendations and a short supportive message in the user's typical tone.”

In another example, the server may generate a prompt sentence for news recommendation:
“Based on the user's interests in artificial intelligence and software engineering, suggest five latest technology news articles and explain in one sentence why each article would interest this user.”

The server combines the base persona prompt sentence and the task-specific prompt into a single prompt string. The server then sends this prompt string, together with any necessary additional parameters, to the generative AI model inference module.

By programmatically generating prompt sentences using structured personality information rather than static templates, the server reduces the need for repeated manual tuning of prompts and supports automatic adaptation to changes in user behavior. This improves the stability and predictability of the generative AI model's behavior and reduces wasted computation due to poorly conditioned prompts.

### G. Content Retrieval, Selection, and Ranking

The server retrieves content information from external information providing services via network requests. The server uses application programming interfaces to query for content items such as news articles, music tracks, or videos, with query parameters derived from the interest vector stored in the personality profile. The server receives response data containing identifiers, titles, summaries, and category metadata for each content item. The server stores these items in a temporary content candidate table.

The server then computes a matching score between each content item and the user's personality information. The server may compute similarity between the item's category vector and the user's interest vector using a similarity function such as cosine similarity. The server may also adjust scores based on the estimated current emotional state, promoting content types known to correlate with improvements in the user's emotional state. For example, if the user is currently tired, the server may boost content labeled as relaxing or low cognitive load.

The server ranks the content items by the computed score and selects a top subset as a personalized content set. The server thereby reduces the amount of data that needs to be transmitted to the terminal and focuses computational resources on a smaller set of items during subsequent text generation, leading to lower communication load and improved latency compared to systems that push large unfiltered feeds to the client.

### H. Generation of Response Information and Recommendation Information

The server uses the generative AI model to generate natural language texts that accompany content selections or that function as stand-alone responses. The server sends the constructed prompt sentence to the generative AI model with the selected content item metadata. The generative AI model outputs one or more text sequences, which the server treats as response information or recommendation information.

For example, when the user's recent activity suggests interest in complex science-fiction movies, the server may generate and use a prompt sentence such as:
“The user's recent activity shows strong interest in science-fiction movies with complex plots and philosophical themes. Based on this preference, generate a list of five recommended movies and explain in one or two sentences why each movie matches the user's taste.”

The generative AI model returns a structured set of movie titles and explanations, which the server then formats and stores as part of the personalized content set. By conditioning the model with explicit personality information and task parameters, the server increases the probability that generated outputs align with user preferences, thereby reducing the need for repeated generation attempts and manual corrections.

### I. Digital Personality and Posthumous Communication

The server uses the personality profile and the generative AI model to implement a digital personality for the user. The server treats the personality profile as a persistent configuration of the model's expected style, interests, and emotional tendencies. The server further stores conditions set by the user during the user's lifetime regarding who may receive communications from the digital personality, which channels to use, what topics are allowed, and what timing rules apply.

After death of the user or during long-term absence, the server refers to these conditions and continues to generate response information or content sets for specified recipients. For example, the server may generate a prompt sentence such as:
“Using the digital personality of the user, who was enthusiastic about the latest technology and often used casual but excited language, generate a short message to a family member commenting on a newly released computing device.”

The server transmits the resulting messages via communication protocols such as electronic mail or short text messaging. The terminals of the recipients display the messages, and the recipients can respond. The server processes these responses as reaction information and feedback information, storing them and using them to update the personality profile and prompt templates, for example by adjusting interest weights or preferred expressions over time.

This architecture allows the server to maintain consistent communication style and content generation even when the user is no longer actively providing new data. It is not a simple archival replay of stored messages, but a dynamic control mechanism over a generative AI model, guided by structured personality parameters.

### J. Feedback Incorporation and Model Control Improvement

The server acquires reaction information and feedback information from recipients, such as whether messages were opened, whether links were clicked, or whether likes or ratings were provided. The server stores these signals in a feedback table linked to the corresponding response information and prompt sentences.

The server analyzes the feedback data to evaluate which prompt constructions and personality parameter settings produce more effective communication. The server may compute performance metrics such as average click-through rate per prompt template, average positive feedback per emotional tone, and error rates such as instances where generated content conflicted with known user preferences.

The server adjusts the personality profile and prompt templates based on these metrics. For example, the server may increase the weight of topics that consistently receive positive feedback or decrease the use of particular stylistic elements that correlate with low engagement. The server may also adjust hyperparameters for similarity thresholds used in content ranking to reduce the inclusion of weakly relevant items, thereby saving bandwidth and computation.

This feedback-driven adjustment constitutes a control loop around the generative AI model, enhancing the model's effective behavior without retraining the entire model from scratch. As a result, the server improves the overall computational efficiency, reduces redundant model calls, and stabilizes the semantic quality of generated outputs.

### K. Technical Effects and Improvements to Computer Technology

The described system improves the functioning of the server and the terminal in several concrete technical ways. The server uses explicit, reusable feature vectors and structured personality profiles to avoid reprocessing raw text data for each personalization task, thus reducing processing time and energy consumption. The server uses similarity-based ranking and thresholding to filter external content before transmission, which reduces network bandwidth usage and memory consumption on the terminal.

The server's use of machine-readable personality parameters and automatically generated prompt sentences allows the server to control a complex generative AI model with greater precision. This reduces the variance in model outputs and the need for repeated generation attempts, which directly lowers computation cost. The feedback loop mechanism further refines model conditioning parameters and prompt templates in a data-driven manner, which is not achievable by manual human operations at scale.

The neural network architectures used for emotion classification and generation are configured with specific loss functions, activation functions, and weight update procedures. For example, the server may use stochastic gradient descent with mini-batches, adaptive learning rate algorithms, and regularization techniques to improve convergence and avoid overfitting. The server may optionally apply data augmentation to user text data by paraphrasing or perturbing certain phrases in controlled ways to increase robustness of emotion detection and personality inference.

These technical configurations lead to measurable improvements such as higher accuracy in emotion classification, more consistent recommendation relevance, shorter response generation times, and reduced communication overhead. The system therefore constitutes an improvement in computer technology rather than a mere automation of human decision-making.

### L. Alternative Embodiments and Variations

The server may implement alternative machine learning architectures for some components. For example, instead of a topic model, the server may use clustering algorithms in the embedding space to detect interest clusters. Instead of a transformer-based generative model, the server may use another autoregressive language model architecture that supports conditioning on persona tokens.

The server may store feature vectors in a dedicated vector database to support approximate nearest-neighbor queries. The server may implement caching mechanisms for frequently used combinations of personality parameters and task types, reusing previously computed prompts or even previously generated outputs under certain conditions, to further lower latency and computation.

The terminal may implement local pre-processing, such as temporary caching of user input data and preliminary text normalization, before sending data to the server. The terminal may also perform limited local ranking of content items when network connectivity is constrained, using simplified scoring rules derived from the personality profile.

In all such variations, the server, the terminal, and the described data structures and processing flows cooperate to construct and use a digital personality in a way that modifies how data is stored, represented, and processed inside the computer system. The specific configuration of personality profiles, prompt sentence generation, generative AI model control, content filtering, and feedback-driven updates provides technical effects that go beyond conventional rule-based personalization or simple data retrieval systems.

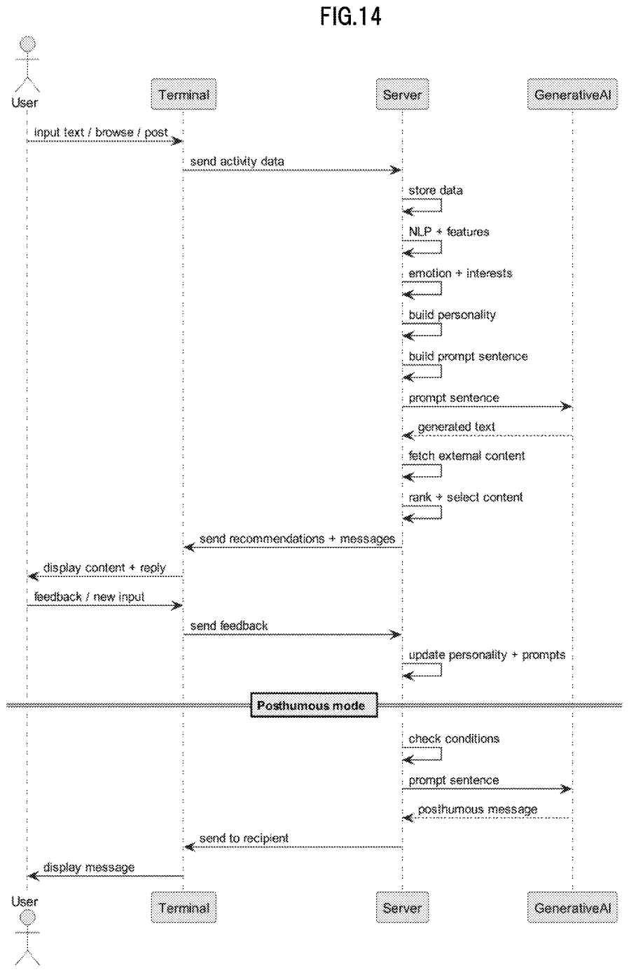

The following describes the processing flow using FIG. 14.

### Step 1:

The terminal acquires user activity data and sends it to the server.

The terminal receives, as input, user operations such as text inputs (chat messages, search queries, form entries), navigation events (visited URLs, clicked links), and posting operations on information sharing services. The terminal converts these operations into structured records containing at least a user identifier, a timestamp, a source application identifier, and a raw text field. The terminal batches multiple records into a data packet and transmits the packet to the server via a communication interface using a network protocol such as HTTPS. The output of this step is a stream of structured user activity records delivered to the server.

### Step 2:

The server stores raw user activity data in a database.

The server receives, as input, the structured user activity records transmitted from the terminal and, optionally, activity data acquired from external information processing apparatuses (such as logs from external services). The server inserts each record into a user activity table in a relational database, assigning a unique record identifier and storing fields such as user identifier, timestamp, source type, and raw text. The server marks each record with a processing status flag indicating that natural language processing has not yet been performed. The output of this step is a set of persisted user activity records ready for subsequent processing.

### Step 3:

The server performs text normalization and tokenization.

The server takes, as input, user activity records whose processing status indicates “unprocessed,” retrieving the raw text fields and associated metadata. The server uses natural language processing software to perform text normalization, including lowercasing, removal of special characters and unnecessary whitespace, and unification of punctuation. The server then performs tokenization to segment the normalized text into sentences and tokens, and may apply lemmatization and part-of-speech tagging. The server stores the normalized text and token lists in separate fields or related tables, and updates the processing status to indicate that the record has been normalized and tokenized. The output of this step is a set of normalized, tokenized text records suitable for feature extraction.

### Step 4:

The server generates numerical feature vectors from text.

The server uses, as input, the normalized and tokenized text associated with each activity record. The server applies an embedding model implemented in a machine learning framework to convert each text segment into a numerical vector, such as a sentence embedding. The server may aggregate token-level embeddings into a single vector by averaging or using an attention-based pooling mechanism. The server stores the resulting vectors in a feature table, linked to the corresponding activity record identifiers. The server marks each record as “feature extracted” in the processing status. The output of this step is a set of feature vectors representing user activity texts in a machine-readable form.

### Step 5:

The server estimates the emotional state associated with each text record.

The server takes, as input, the feature vectors computed in Step 4. The server feeds each vector into an emotion classifier implemented as a multi-layer neural network, which computes a probability distribution over predefined emotion categories such as joy, sadness, anger, and neutral. The server selects the category with the highest probability as the primary emotion label and records the associated confidence score. The server writes these emotion labels and scores into an emotion annotation table, referencing the original activity records. The server sets an emotion annotation status flag to indicate completion. The output of this step is a set of emotion annotations linked to individual activity records.

### Step 6:

The server aggregates emotional tendencies and extracts user interests.

The server uses, as input, the emotion annotations and the feature vectors for all activity records of a particular user. The server groups records by user identifier and optionally by time intervals or content categories. The server computes aggregate statistics such as the proportion of positive versus negative emotions, average emotional intensity per topic, and emotion variance over time. In parallel, the server applies a topic extraction or clustering algorithm to the feature vectors to derive an interest vector for each user, indicating preferences for topics such as technology, music, or sports. The server writes these aggregated statistics and interest vectors into the personality profile table. The output of this step is updated personality profiles that include emotional tendency parameters and interest weights for each user.

### Step 7:

The server analyzes language patterns and constructs personality information.

The server takes, as input, the normalized text and tokenized sequences associated with all activity records of a user. The server computes language pattern metrics such as average sentence length, distribution of sentence lengths, frequency of particular expressions, and commonly used phrases or idioms. The server may also calculate vocabulary diversity indices and frequency of specific stylistic markers (for example, exclamation marks). The server combines these language pattern metrics with the emotional tendency and interest vectors stored in the personality profile table to produce a comprehensive personality information record for the user. The server stores this personality information as structured fields, such as numerical parameters and categorical descriptors. The output of this step is a personality profile that characterizes the user's informational individuality, language pattern, interests, and emotional tendencies.

### Step 8:

The server constructs a base persona prompt sentence.

The server uses, as input, the personality profile for a given user, including interest vectors, emotional tendencies, and language pattern descriptors. The server converts this structured information into a natural language description that can be consumed by a generative AI model. For example, the server generates a base persona prompt sentence such as: “You are the digital personality of a user who writes short, friendly messages, often with light humor, and who is highly interested in technology and jazz music, and typically expresses an optimistic tone.” The server stores this base persona prompt sentence in a prompt template table, associated with the user identifier. The output of this step is a reusable base persona prompt sentence that summarizes the user's personality for conditioning a generative AI model.

### Step 9:

The server constructs a task-specific prompt sentence.

The server takes, as input, the base persona prompt sentence from Step 8, the current or recent emotional state of the user (for example, from the latest emotion annotations), the user's interest vector, and a target task specification such as “recommend news” or “generate a reply.” The server generates a task-specific prompt sentence that incorporates these elements. For example, the server may generate: “Based on the user's current emotion ‘tired’ and their interest in relaxing music and comedies, generate three content recommendations and a short supportive message in the user's typical tone.” The server concatenates or otherwise combines the base persona prompt and the task-specific portion into a single prompt sentence to be provided to a generative AI model. The output of this step is a fully constructed prompt sentence tailored to the user and the target task.

### Step 10:

The server retrieves candidate content from external information providing services.

The server uses, as input, the user's interest vector from the personality profile and optional context parameters (such as preferred content type or recency window). The server formulates queries to external information providing services, including parameters such as topic keywords and category filters derived from the interest vector. The server sends these queries via network interfaces using APIs and receives content information, including identifiers, titles, summaries, and category metadata for each item. The server stores this information in a content candidate table, indexed by user identifier and retrieval time. The output of this step is a set of candidate content items obtained from external sources.

### Step 11:

The server selects and ranks content items to form a personalized content set.

The server takes, as input, the candidate content items from Step 10 and the personality information for the user, including interest vectors and current emotional state. The server computes a matching score between each content item's category or topic vector and the user's interest vector, for example using cosine similarity. The server then applies weighting factors based on the emotional state to adjust scores (for example, boosting relaxing content when the user is tired). The server ranks the content items according to the adjusted scores and selects a top subset as the personalized content set. The server records this set as a list of item identifiers with associated scores and metadata. The output of this step is a personalized content set optimized for the user's interests and emotional state.

### Step 12:

The server generates response information or recommendation information using a generative AI model.

The server uses, as input, the constructed prompt sentence from Step 9 and, optionally, metadata for the personalized content set from Step 11 (such as titles and short descriptions).

The server provides the prompt sentence and any content metadata to the generative AI model, which is implemented as a transformer-based neural network running on the server. The model processes the input tokens and generates output token sequences that correspond to natural language text. The server decodes these sequences into response information or recommendation information, such as lists of recommended items with explanatory text or conversational replies that mimic the user's style. For example, the server may use a prompt sentence such as: “The user's recent activity shows strong interest in science-fiction movies with complex plots and philosophical themes. Based on this preference, generate a list of five recommended movies and explain in one or two sentences why each movie matches the user's taste.” The output of this step is a set of generated text messages representing personalized recommendations or responses.

### Step 13:

The server transmits generated information and content references to the terminal.

The server takes, as input, the response information or recommendation information from Step 12 and the identifiers and links of the personalized content set from Step 11. The server packages these data into a response payload, including structured fields such as message text, item titles, URLs, and thumbnail references. The server sends this payload to the terminal via a network protocol, for example as a JSON message over HTTPS or via a push notification service. The output of this step is a data transmission that delivers generated text and content references to the terminal.

### Step 14:

The terminal displays personalized messages and content to the user.

The terminal uses, as input, the response payload from Step 13. The terminal parses the payload and maps message texts and content items to user interface components such as message bubbles, lists, and clickable cards. The terminal renders the texts in the display device and associates each recommended item with a selectable UI element that links to the underlying content. The terminal may also generate notification banners or alerts to inform the user that new personalized information is available. The output of this step is a visual and/or auditory presentation that allows the user to read or interact with the personalized content and messages.

### Step 15:

The user interacts with the digital personality and content.

The user takes, as input, the messages and content presented by the terminal. The user reads the generated responses, selects content items, and optionally sends new text inputs such as questions, comments, or feedback. The user may perform actions including “like,” “dislike,” rating, or replying to messages. The terminal captures these user actions as new interaction records containing the user identifier, the referenced message or content item identifier, the type of action, and any additional text. The terminal sends these interaction records to the server. The output of this step is user-generated interaction and feedback data transmitted back to the server.

### Step 16:

The server records reaction information and feedback information.

The server receives, as input, the interaction and feedback records from the terminal. The server writes these records into a feedback table, associating them with the corresponding response information and content items using identifiers. The server computes metrics such as click-through rate, open rate, and average rating per message type or prompt template. The server may update counters or moving averages for each personality profile and prompt template. The output of this step is an updated set of feedback records and evaluation metrics stored in the server's database.

### Step 17:

The server updates personality information and prompt templates based on feedback.

The server uses, as input, the feedback records and metrics from Step 16, along with existing personality profiles and prompt templates. The server analyzes how different personality parameters and prompt constructions correlate with positive or negative feedback, for example by computing correlations between interest weights and click-through rates or between stylistic descriptors and user ratings. The server adjusts personality parameters, such as increasing the weight for topics that consistently receive positive feedback and decreasing weights for topics with low engagement. The server may also modify prompt templates by adjusting wording or conditions to improve clarity and relevance. The server writes the updated parameters and templates back to the personality profile and prompt template tables. The output of this step is refined personality information and prompt templates that improve future generative behavior.

### Step 18:

The server manages posthumous or long-term absence operation of the digital personality.

The server takes, as input, conditions set by the user during the user's lifetime, stored in a settings table, and a status indicator representing whether the user is deceased or absent for a defined period. When the conditions are satisfied, the server activates a posthumous or absence mode for the digital personality. The server selects recipients and channels specified in the conditions, and then performs operations similar to Steps 9 through 13, generating and transmitting response information or personalized content sets to these recipients. For example, the server may use a prompt sentence such as: “Using the digital personality of the user, who was enthusiastic about the latest technology and often used casual but excited language, generate a short message to a family member commenting on a newly released computing device.” The output of this step is continued communication and content delivery to designated recipients even when the user is no longer actively operating the terminal.

### Step 19:

The terminal of a recipient presents posthumous messages, and the recipient can respond.

The terminal of a recipient uses, as input, the data transmitted by the server in Step 18. The terminal displays the messages and any associated content references in its user interface, in a manner similar to Step 14. The recipient may read the messages, access the referenced content, and optionally send replies or feedback. The terminal captures these responses as new interaction records and transmits them to the server, where they are processed as reaction information and feedback information in Steps 16 and 17. The output of this step is a continuing interaction loop between the digital personality and recipients, maintaining the personality-based communication beyond the user's active participation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

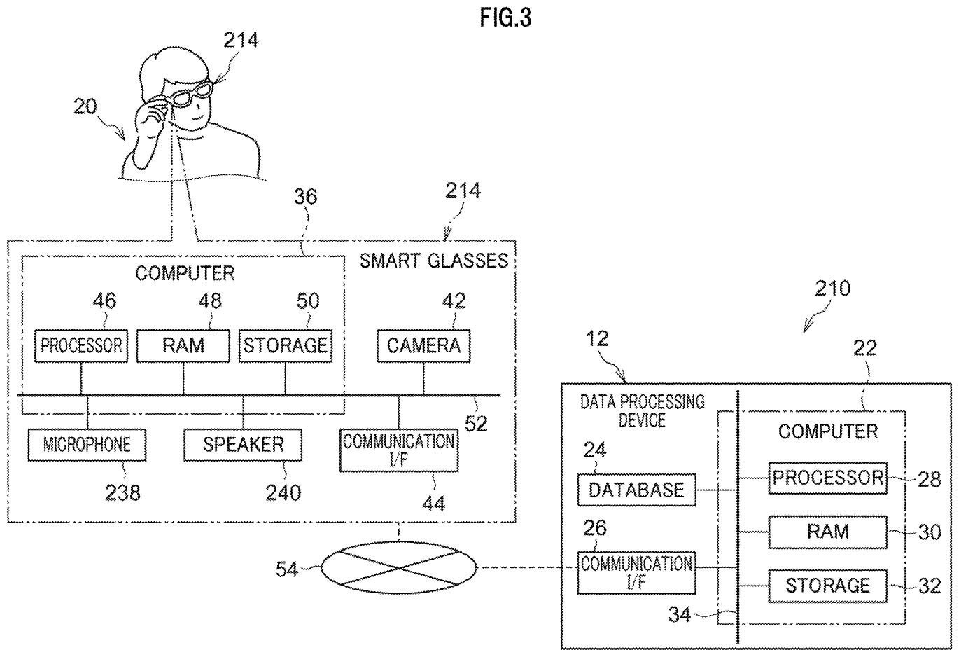

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

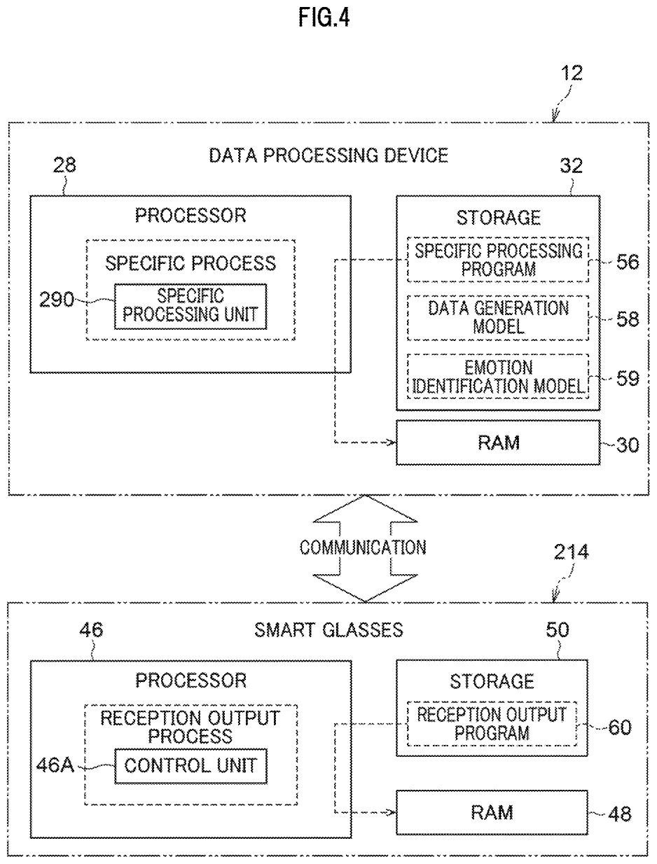

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

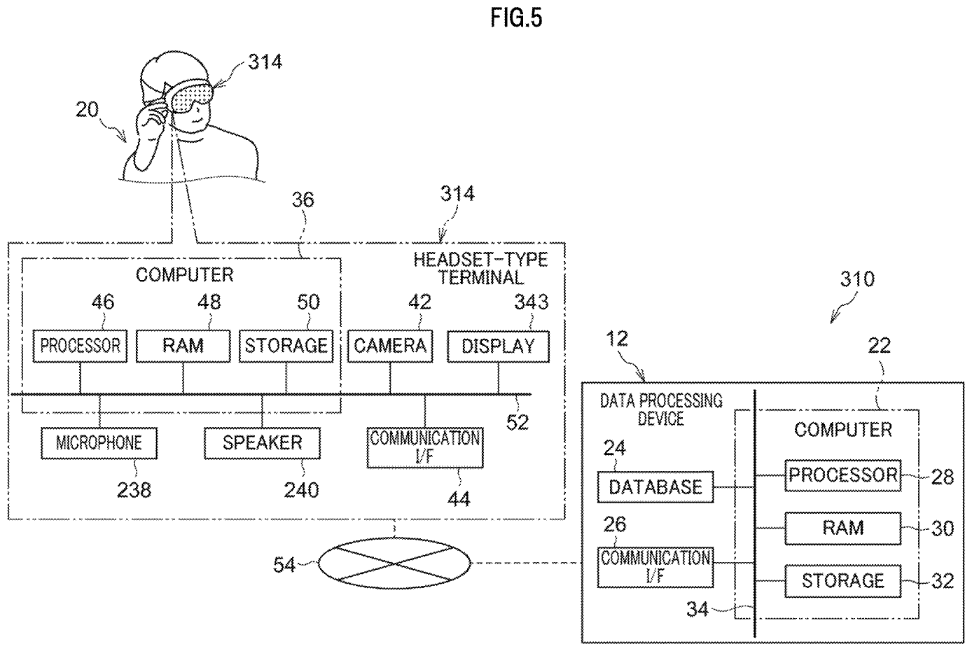

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

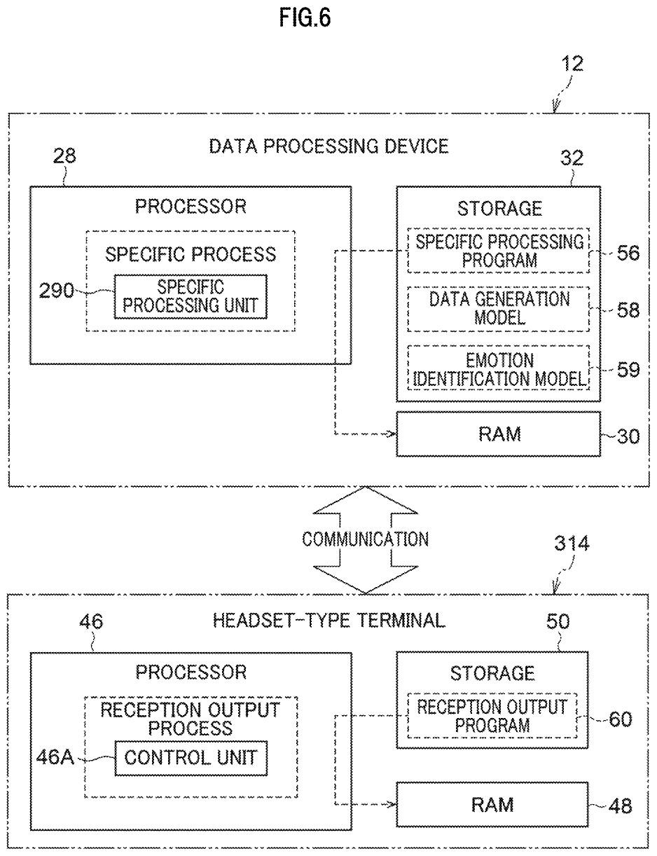

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

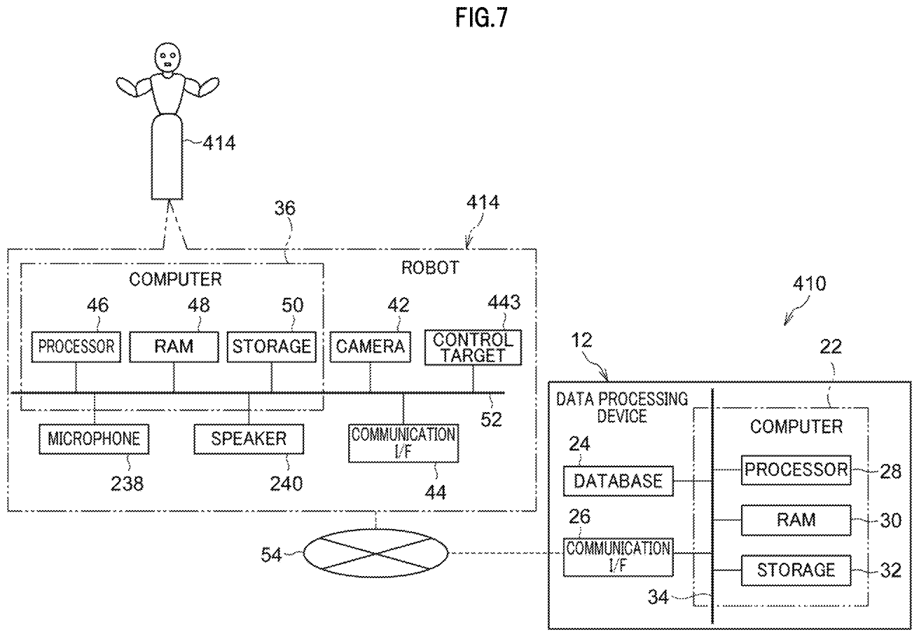

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

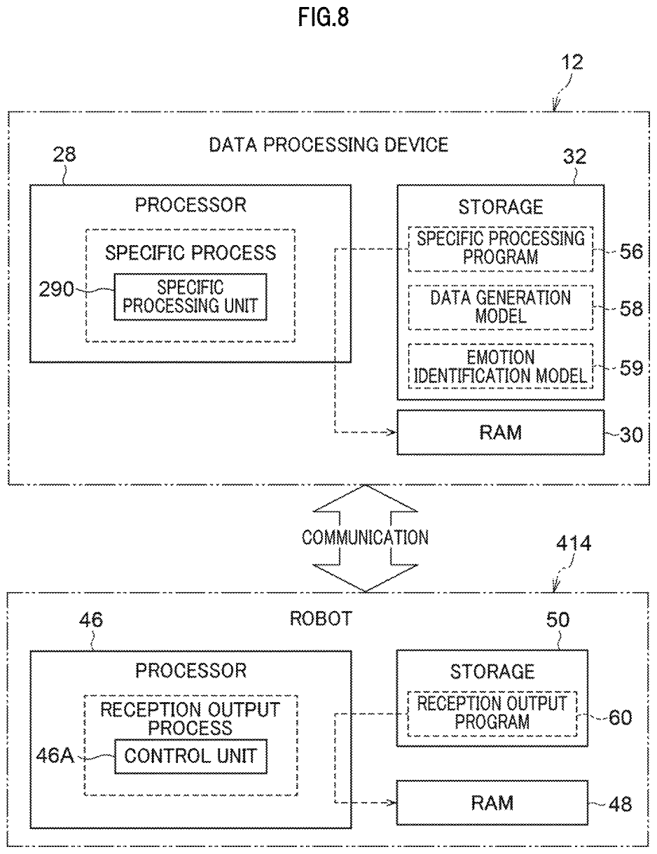

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

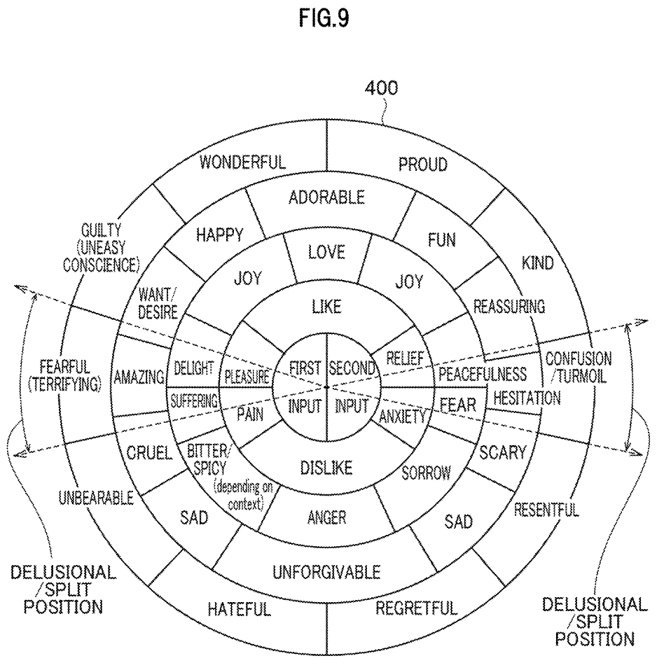

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

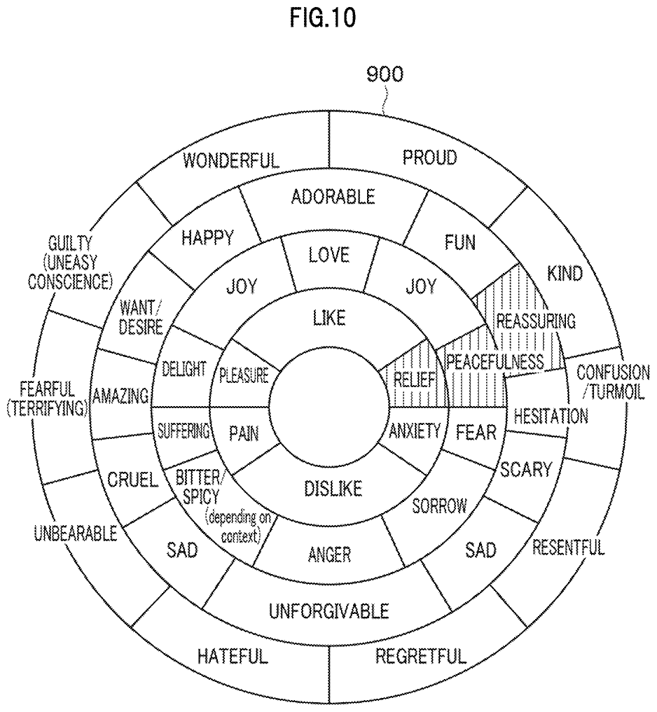

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

### (Supplementary 1)

A system comprising a processor,
wherein the processor is configured to
receive and store, from a terminal, information input data, browsing data, and posting data in an information sharing service as daily information activities of a user,
preprocess and structure the stored information input data, browsing data, and posting data using a database management function and a natural language processing function to generate feature information indicating behavioral characteristics and preference characteristics of the user,
construct a training data set for a generative AI model operating on a machine learning platform by using the feature information and the stored data, and train the generative AI model to generate a model state representing an informational personality specific to the user and a personality profile for each user,
automatically generate a prompt sentence to be input to the generative AI model on the basis of the personality profile for each user and the stored data, input the prompt sentence and the personality profile to the generative AI model, and generate response information or recommendation information corresponding to the informational personality of the user, and
transmit the generated response information or recommendation information to the terminal so that the response information or recommendation information is presented to the user via the terminal.

### (Supplementary 2)

The system according to supplementary 1,
wherein the processor is configured to
sequentially add new information input data, browsing data, and posting data received from the terminal to the stored data, and update the feature information, the generative AI model, and the personality profile for each user so as to dynamically change the response information or the recommendation information in accordance with changes in the behavioral characteristics and the preference characteristics of the user.

### (Supplementary 3)

The system according to supplementary 1,
wherein the processor is configured to
generate, as the response information from the generative AI model, dialogue text or message content based on the informational personality of the user even after the user is absent or deceased, and provide the dialogue text or the message content to a third party via the terminal or another information processing apparatus.

Application Example 1

### (Supplementary 1)

A system comprising a processor and a memory,
wherein the processor is configured to
acquire, via a communication interface, information related to a user's daily information activities from a terminal, the information including character-based input information, information resource viewing information, and posting information on an information sharing platform, obtain structured information corresponding to information resources associated with the acquired information by executing an information acquisition program, and store the acquired information and the structured information in the memory,
perform, by executing an information analysis program, preprocessing, feature extraction, and classification processing on the information stored in the memory to calculate behavioral feature values representing, for each user, an information interest level, an information usage tendency, and an information activity pattern, and generate, based on the behavioral feature values, an attribute set representing an informational persona of the user,
calculate feature values, by executing the information analysis program, for candidate information obtained from an external information supply platform, calculate a similarity between the candidate information and the attribute set, perform selection and ranking of the candidate information based on the similarity, and determine an information candidate group to be provided to the user,
generate, based on the attribute set and the information candidate group, a prompt sentence that specifies the user's information interest, expression style, and desired information format, and generate control information that causes a generative AI model to receive the prompt sentence as input, and
acquire generated information output by the generative AI model in response to the prompt sentence, store the generated information in association with the user in the memory, and transmit the generated information to the terminal.

### (Supplementary 2)

The system according to supplementary 1,
wherein the processor is configured to
execute, by means of the information analysis program, statistical learning processing or machine learning processing on an information activity history of the user stored in the memory and on the candidate information obtained from the external information supply platform, to calculate the behavioral feature values and the similarity, and
wherein the generative AI model is configured to generate response information corresponding to a preference of the user based on the prompt sentence.

### (Supplementary 3)

The system according to supplementary 1,
wherein the processor is configured to
acquire, via the terminal, usage history information including at least one of viewing operations, selection operations, and rejection operations performed by the user on the generated information, store the usage history information as additional information activities in the memory, update the behavioral feature values and the attribute set based on an information activity history including the usage history information, and improve, in a successive manner, the prompt sentence and generation processing by the generative AI model based on the updated attribute set.

### Example 2

### (Supplementary 1)

A system comprising a processor,
wherein the processor is configured to
acquire activity data relating to information input activities, information browsing activities, and information sharing activities performed by a user via an information processing terminal,
preprocess character information included in the activity data by using natural language processing technology so as to generate analysis data, the preprocessing including tokenizing the character information and removing unnecessary information,
extract, from the analysis data, feature quantities indicating a word usage tendency, an emotional expression tendency, and a sentence structure tendency of the user, and generate a feature profile for each user based on the extracted feature quantities,
construct a learning model by using machine learning technology based on the feature profile and the analysis data, and generate a digital persona model that imitates an informational individuality and a dialog style of the user,
generate a prompt sentence, based on the digital persona model and the feature profile, the prompt sentence being configured to instruct an internal or external generative AI model to generate a response that imitates the word usage tendency, the emotional expression tendency, and a writing style of the user, and
input the prompt sentence into the generative AI model so as to cause the generative AI model to generate a response sentence reflecting the informational individuality and the dialog style of the user.

### (Supplementary 2)

The system according to supplementary 1,
wherein the processor is configured to
use the digital persona model to generate a candidate response sentence to an input sentence from the user or from a third party independently of the generative AI model, and select, as a response suitable for the informational individuality of the user, at least one of the candidate response sentence and a response sentence generated by the generative AI model using the prompt sentence.

### (Supplementary 3)

The system according to supplementary 1,
wherein the processor is configured to
store the prompt sentence and the response sentence in association with the user, and update the feature profile and the digital persona model based on the stored information so as to perform a learning process that sequentially reflects a change in the informational individuality and the dialog style of the user.

Application Example 2

### (Supplementary 1)

A system comprising a processor,
wherein the processor is configured to
acquire and store, from a terminal or an external information processing apparatus, information input data, browsing data, and posting data of an information sharing service as daily information activities of a user; and
perform information processing including natural language processing on the stored data to execute text normalization, tokenization, and feature extraction, and to extract attribute information regarding an emotional state and interests of the user; and
generate personality information representing an informational individuality and a language pattern of the user, based on the extracted emotional state and interests, and generate a prompt sentence for input to a generative artificial intelligence model using the personality information as a condition; and
operate the generative artificial intelligence model based on the prompt sentence and the personality information to generate response information or recommendation information that imitates the informational individuality and the emotional state of the user; and
select or rank content information acquired from an external information providing service in accordance with the personality information and the emotional state, and generate a personalized content set; and
transmit the generated response information or the personalized content set to the terminal, and cause the user or another recipient to be presented with the response information or the personalized content set; and
generate and transmit the response information or the content set to the recipient by using the personality information and the generative artificial intelligence model after death of the user or after a long-term absence of the user, based on conditions set during a lifetime of the user; and
acquire reaction information and feedback information from the recipient after transmission, and update the personality information and contents of the prompt sentence based on the reaction information and the feedback information.

### (Supplementary 2)

The system according to supplementary 1,
wherein the processor is configured to
automatically generate, as the prompt sentence input to the generative artificial intelligence model, a conditional sentence including at least the informational individuality, the emotional state, the interests of the user, and a type of a target task, and generate the response information or the recommendation information based on the conditional sentence.

### (Supplementary 3)

The system according to supplementary 1,
wherein the processor is configured to
generate the response information or the recommendation information as a dialogue message by a digital personality that imitates the language pattern, writing style, and emotional expression of the user, and enable continuation of information exchange through the digital personality even after death of the user.

What is claimed is:

1. A system comprising:
circuitry configured to:
receive, via a communication interface coupled to a packet-switched network, activity data comprising text input data, browsing data, and posting data from a terminal device and store the activity data in a storage device;
preprocess and structure the stored activity data using a natural language processing function to generate feature information indicating behavioral characteristics and preference characteristics represented in the activity data;
construct a training data set using the feature information and the stored activity data, and adjust parameters of a generative neural network model using the training data set to produce a model state representing a behavioral profile specific to a user;
automatically generate a prompt sentence based on the behavioral profile and input the prompt sentence together with the behavioral profile to the generative neural network model to produce response information or recommendation information corresponding to the behavioral profile; and
transmit the response information or the recommendation information to the terminal device via the communication interface.

2. The system of claim 1, wherein the circuitry is configured to preprocess the text input data and the posting data by applying tokenization, stop-word removal, and term frequency-inverse document frequency weighting to extract lexical feature vectors, and to apply click-sequence pattern analysis to the browsing data to extract navigation behavior feature vectors.

3. The system of claim 2, wherein the circuitry is configured to concatenate the lexical feature vectors and the navigation behavior feature vectors into a unified feature matrix and apply dimensionality reduction using principal component analysis to produce a compact behavioral feature representation for inclusion in the feature information.

4. The system of claim 3, wherein the circuitry is configured to construct the training data set by pairing the compact behavioral feature representation with historical response records from the storage device as training samples, and to partition the training data set into training and validation subsets.

5. The system of claim 4, wherein adjusting parameters of the generative neural network model applies a cross-entropy loss function between model-generated token sequences and reference response sequences from the training data set, and updates model weights using a gradient-based optimization algorithm with mini-batch sampling.

6. The system of claim 5, wherein the circuitry is configured to trigger incremental parameter adjustment when a drift metric computed between a current behavioral feature representation and a stored behavioral feature representation exceeds a drift threshold, indicating a change in behavioral characteristics.

7. The system of claim 1, wherein the behavioral profile is structured as a profile record comprising a lexical preference vector, a topic affinity vector, and a navigation pattern vector, stored in a profile table in the storage device and linked to a user identifier.

8. The system of claim 7, wherein the prompt sentence is generated by constructing a profile encoding section from the behavioral profile record and appending a content request section specifying the type of response information or recommendation information, and the circuitry is configured to format the profile encoding section as a structured text block readable by the generative neural network model.

9. The system of claim 8, wherein the circuitry is configured to update the behavioral profile record by recomputing the lexical preference vector, the topic affinity vector, and the navigation pattern vector using a sliding time window over the most recently accumulated activity data.

10. The system of claim 1, wherein the circuitry is configured to apply a novelty detection model to the activity data to identify activity records that deviate from established behavioral patterns, and to weight novelty-detected records more heavily when constructing the training data set.

11. The system of claim 10, wherein the novelty detection model applies a one-class classification algorithm trained on prior activity data and produces a novelty score for each activity record, and the circuitry is configured to apply a weight proportional to the novelty score when sampling training records from the training data set.

12. The system of claim 1, wherein the circuitry is configured to generate a plurality of candidate prompt sentences conditioned on different behavioral profile dimensions, input each candidate prompt sentence to the generative neural network model, and select among resulting outputs based on a diversity score computed over the set of outputs.

13. The system of claim 12, wherein the diversity score is computed as the average pairwise cosine distance between output token embeddings of the candidate outputs, and the circuitry is configured to select the output with the highest diversity score as the response information.

14. The system of claim 1, wherein the circuitry is configured to store each generated response information and recommendation information record in the storage device together with a timestamp and the associated behavioral profile record, and to use the stored records as additional training samples for subsequent parameter adjustment operations.

15. The system of claim 14, wherein the circuitry is configured to compute a consistency metric between successive response information records and the associated behavioral profile record, and to flag response information records below a minimum consistency threshold for exclusion from subsequent training data sets.

16. The system of claim 1, wherein the circuitry is configured to receive context data from the terminal device comprising a current session context and a task description, and to append the context data as an additional context section to the prompt sentence before inputting the prompt sentence to the generative neural network model.

17. The system of claim 16, wherein the circuitry is configured to weight the additional context section relative to the behavioral profile section in the prompt sentence by adjusting a context weight parameter based on a recency metric computed from the activity data, increasing context weight when recent activity data exhibits high novelty.

18. A system comprising:
circuitry configured to:
receive, via a communication interface coupled to a packet-switched network, activity data comprising text input data, browsing data, and posting data from a terminal device, apply tokenization and term frequency-inverse document frequency weighting to extract lexical feature vectors, and apply click-sequence pattern analysis to the browsing data to extract navigation behavior feature vectors;
concatenate the lexical feature vectors and the navigation behavior feature vectors into a unified feature matrix, apply dimensionality reduction to produce a compact behavioral feature representation, and structure a behavioral profile record comprising a lexical preference vector, a topic affinity vector, and a navigation pattern vector in a storage device;
construct a training data set by pairing the compact behavioral feature representation with historical response records, and adjust parameters of a generative neural network model using a cross-entropy loss function and a gradient-based optimization algorithm, triggering incremental adjustment when a drift metric between current and stored behavioral feature representations exceeds a drift threshold;
generate a prompt sentence comprising a profile encoding section from the behavioral profile record and a content request section, input the prompt sentence together with the behavioral profile record to the generative neural network model to produce response information or recommendation information; and
transmit the response information or the recommendation information to the terminal device via the communication interface and store the output together with the associated behavioral profile record as an additional training sample.

19. The system of claim 18, wherein the circuitry is configured to generate a plurality of candidate prompt sentences conditioned on different behavioral profile dimensions, compute pairwise cosine distance diversity scores over the resulting output token embeddings, and select the output with the highest diversity score as the response information or recommendation information.

20. A method comprising:
receiving, via a communication interface coupled to a packet-switched network, activity data comprising text input data, browsing data, and posting data from a terminal device and storing the activity data in a storage device;
preprocessing and structuring the stored activity data using a natural language processing function to generate feature information indicating behavioral characteristics and preference characteristics;
constructing a training data set using the feature information and adjusting parameters of a generative neural network model to produce a model state representing a behavioral profile specific to a user;
generating a prompt sentence based on the behavioral profile and inputting the prompt sentence to the generative neural network model to produce response information or recommendation information; and
transmitting the response information or the recommendation information to the terminal device via the communication interface.
